(19) United States
(12) Patent Application Publication
(10) Pub. No.: US 2026/0077595 A1
(43) Pub. Date: Mar. 19, 2026

(54) DRAWING MACHINE AND CLEANING UNIT

(71) Applicant: KEYENCE CORPORATION, Osaka (JP)

(72) Inventors: Shota Matsuzaki, Osaka-shi (JP); Ryohei Suzaki, Osaka-shi (JP)

(73) Assignee: KEYENCE CORPORATION, Osaka (JP)

(21) Appl. No.: 19/325,893

(22) Filed: Sep. 11, 2025

(30) Foreign Application Priority Data
Sep. 18, 2024 (JP) 2024-160598

(51) Int. Cl. B41J 2/165

(52) U.S. Cl. CPC B41J 2/16535; B41J 2/16502; B41J 2/1652

(57) ABSTRACT

Intended cleaning of a nozzle is enabled without inducing a failure of the nozzle. A drawing machine includes: a print head that ejects ink supplied from an ink tank toward an object to be drawn that is being conveyed; a nozzle group including a plurality of nozzles arranged side by side on one end face of the print head; a purge control section that executes a purge process of causing ink remaining in a flow path from the ink tank to the nozzle group to leak to an outside through the nozzle group; and a cleaning unit that includes a wiping member that wipes off an adhering matter adhered to the nozzle group by the purge process and positions the wiping member with respect to the nozzle group in a state of abutting on the one end face of the print head.

### CROSS-REFERENCE TO RELATED APPLICATIONS

The present application claims foreign priority based on Japanese Patent Application No. 2024-160598, filed Sep. 18, 2024, the contents of which are incorporated herein by reference.

### BACKGROUND OF THE INVENTION

### 1. TECHNICAL FIELD The present disclosure relates to a drawing machine that ejects ink and a cleaning unit of the drawing machine.

### 2. DESCRIPTION OF THE RELATED ART

For example, a drop on demand (DOD) type inkjet print apparatus that performs printing by ejecting ink onto a packaging material such as cardboard is known (See, for example, JP2020-131141A).

A DOD type inkjet print apparatus is equipped with a print head in which a large number of nozzles are arranged in a direction orthogonal to a conveying direction of an object to be drawn.

Meanwhile, in a case where contamination such as residual ink, dust, dirt, or the like adheres to the nozzles arranged on a front end surface of the print head, a user performs wiping work with cloth so as not to clog the nozzles.

However, since a large number of nozzles are arranged on a narrow front end surface of the print head, and the size of each nozzle is minute, it is difficult for the user to adjust a force when wiping work with cloth is performed. In a case where wiping is performed with too weak a force, there is a possibility that dirt cannot be sufficiently wiped off. On the other hand, in a case where wiping is performed with too strong a force, if dust or dirt is caught, there is a possibility that a nozzle failure occurs.

### SUMMARY OF THE INVENTION

The present disclosure has been made in view of such a point, and an object of the present disclosure is to enable intended cleaning of a nozzle without inducing a failure of the nozzle.

In order to achieve the above object, a drawing machine according to one embodiment of the present disclosure can be assumed to be a drawing machine that ejects ink for drawing information on an object to be drawn conveyed by a conveyor. The drawing machine includes: an ink tank configured to accommodate ink; a print head configured to eject ink supplied from the ink tank toward the object to be drawn that is being conveyed; a nozzle group including a plurality of nozzles arranged side by side on one end face of the print head; a purge control section configured to execute a purge process of causing ink remaining in a flow path from the ink tank to the nozzle group to leak to an outside through the nozzle group; and a cleaning unit including a wiping member that wipes off an adhering matter adhered to the nozzle group by the purge process and configured to position the wiping member with respect to the nozzle group in a state of abutting on the one end face of the print head.

Furthermore, a cleaning unit detachably attached to the drawing machine can be assumed. The cleaning unit includes: a wiping member configured to wipe off an adhering matter adhered to the nozzle group by the purge process; and an attachment portion detachably attached to one end face of the print head on which the nozzle group is arranged and configured to position the wiping member with respect to the nozzle group.

According to this configuration, since the wiping member is positioned with respect to the nozzle group arranged on the one end face in a state where the cleaning unit is attached to the one end face of the print head, a relative positional relationship between the wiping member and the nozzle group becomes a predetermined positional relationship. As a result, the force when the wiping member comes into contact with the nozzle group is not too weak or too strong, and the force can be appropriately adjusted.

As described above, since in the state where the cleaning unit is attached to the one end face of the print head, the force when the wiping member comes into contact with the nozzle group can be adjusted to an appropriate level of force, the nozzle can be cleaned as intended without inducing a failure of the nozzle.

### BRIEF DESCRIPTION OF THE DRAWINGS

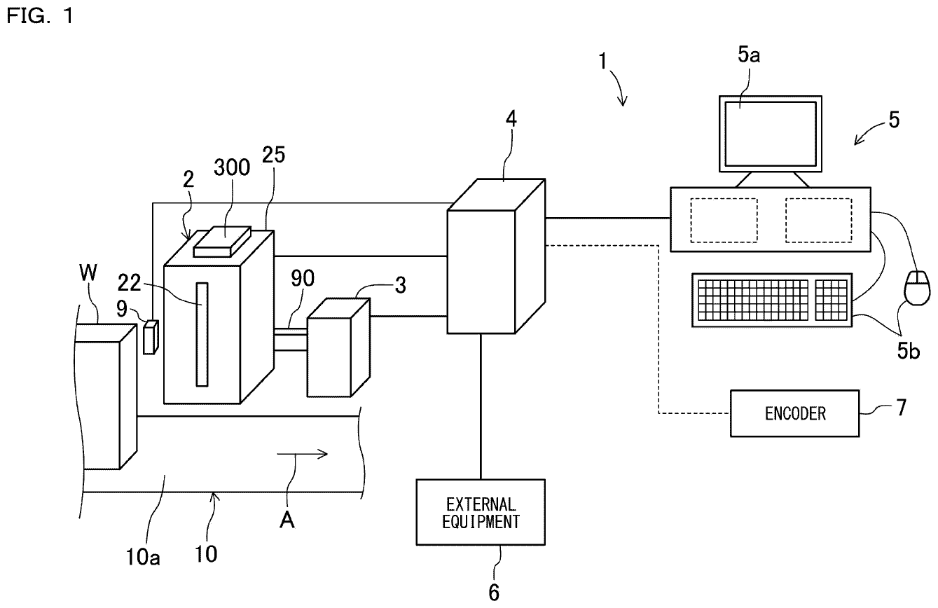

FIG. 1 is a diagram illustrating an overall configuration of an inkjet print apparatus according to an embodiment of the present invention;

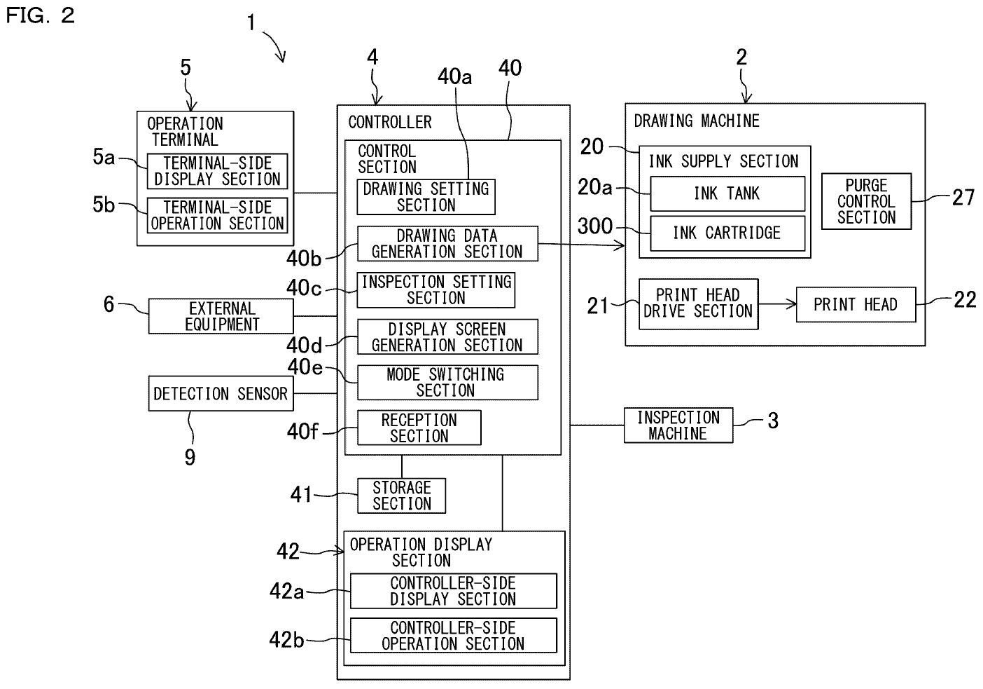

FIG. 2 is a block diagram of an inkjet print apparatus;

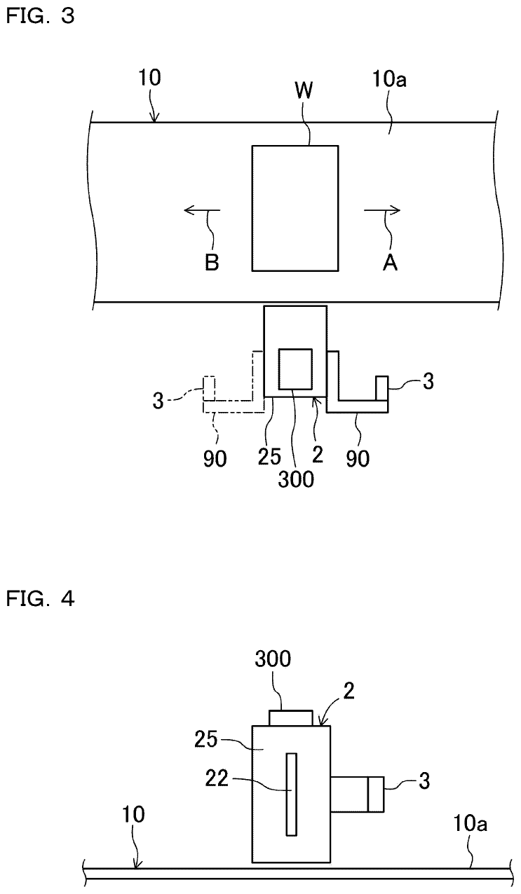

FIG. 3 is a plan view illustrating an installation example of a drawing machine and an inspection machine;

FIG. 4 is a front view illustrating an installation example of the drawing machine and the inspection machine;

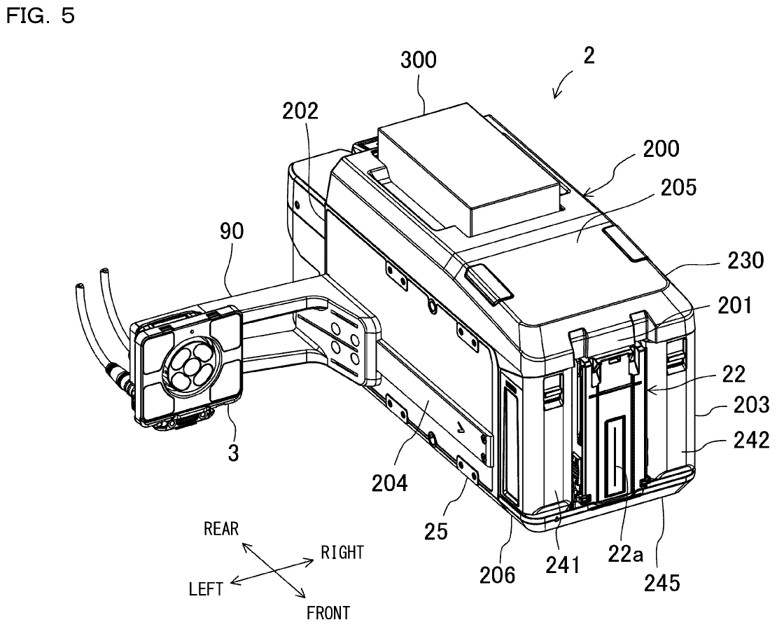

FIG. 5 is a perspective view of the drawing machine as viewed from the front;

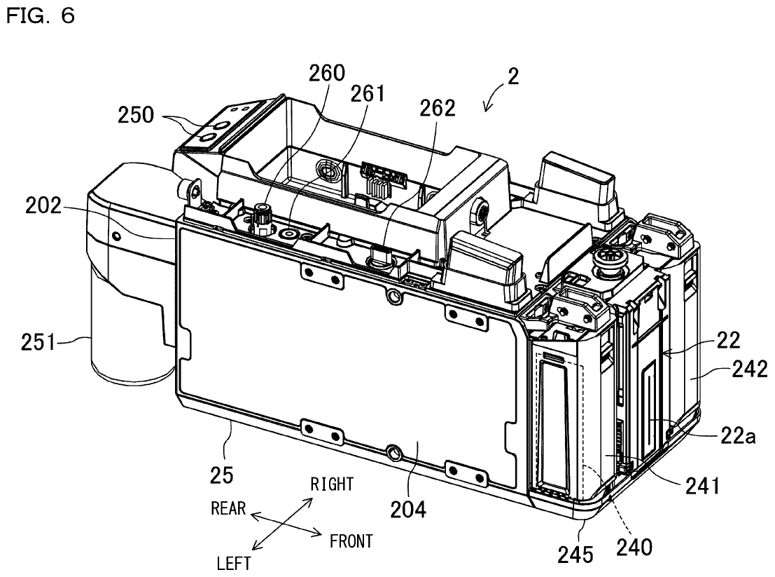

FIG. 6 is a perspective view of the drawing machine with an upper cover detached as viewed from above;

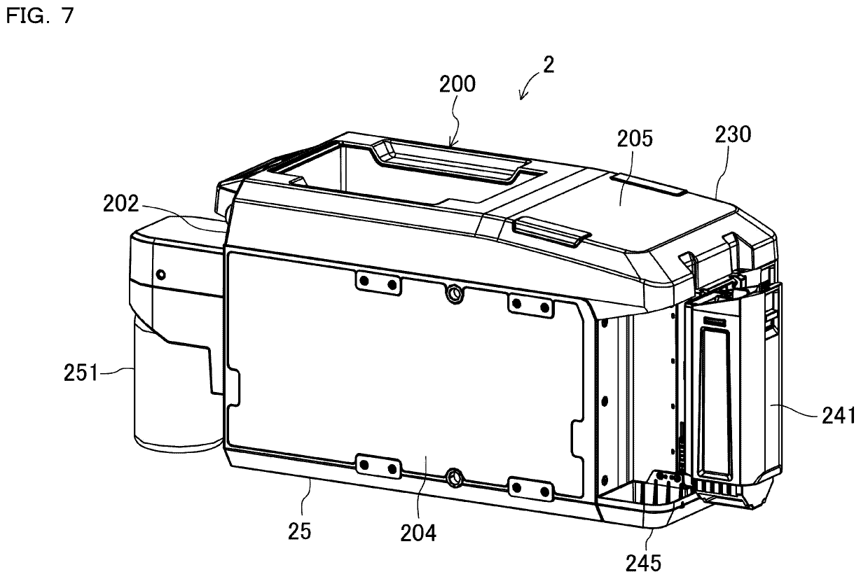

FIG. 7 is a perspective view illustrating a state in which a casing accommodating an absorber is detached;

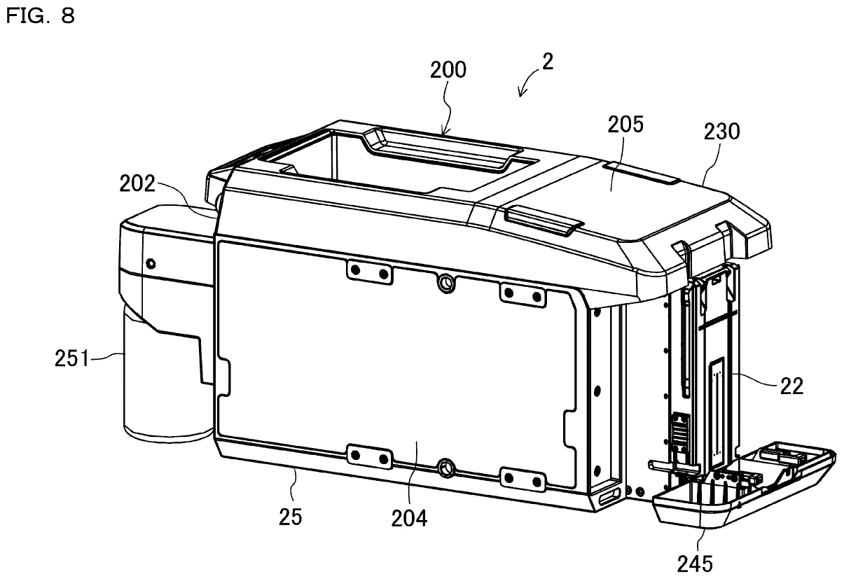

FIG. 8 is a perspective view illustrating a state in which an ink reception portion is detached;

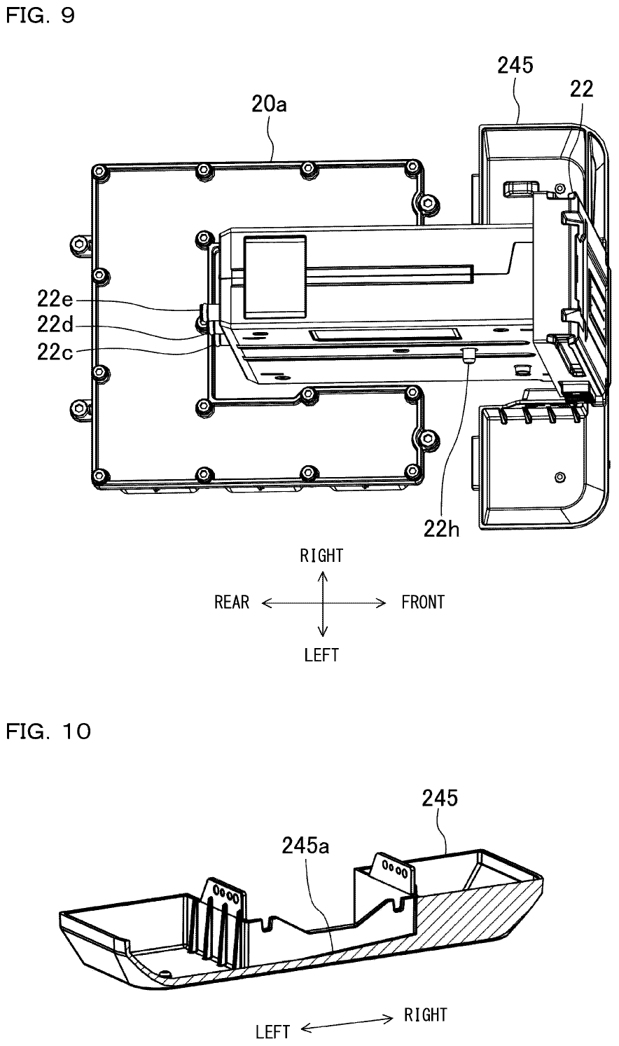

FIG. 9 is a view illustrating a positional relationship of a print head, an ink reception portion, and an ink tank as viewed from above;

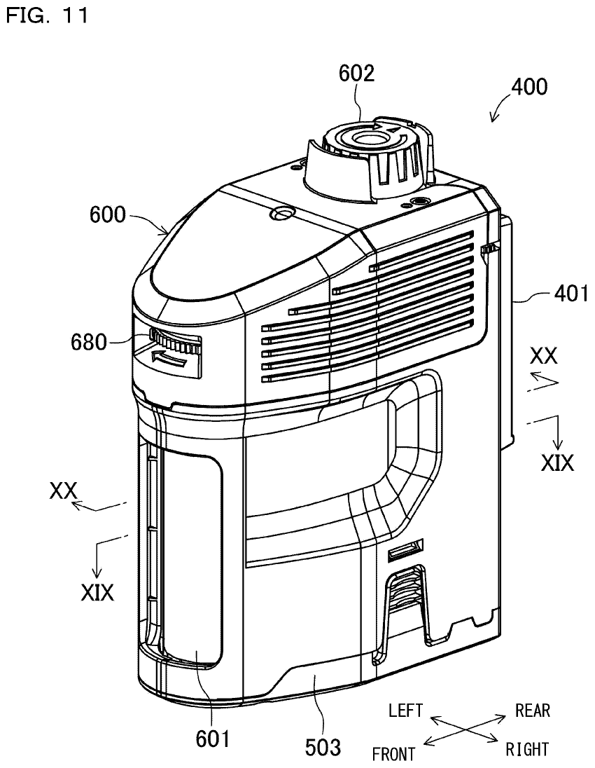

FIG. 10 is a cross-sectional view of the ink reception portion;

FIG. 11 is a perspective view of a cleaning unit as viewed from the front;

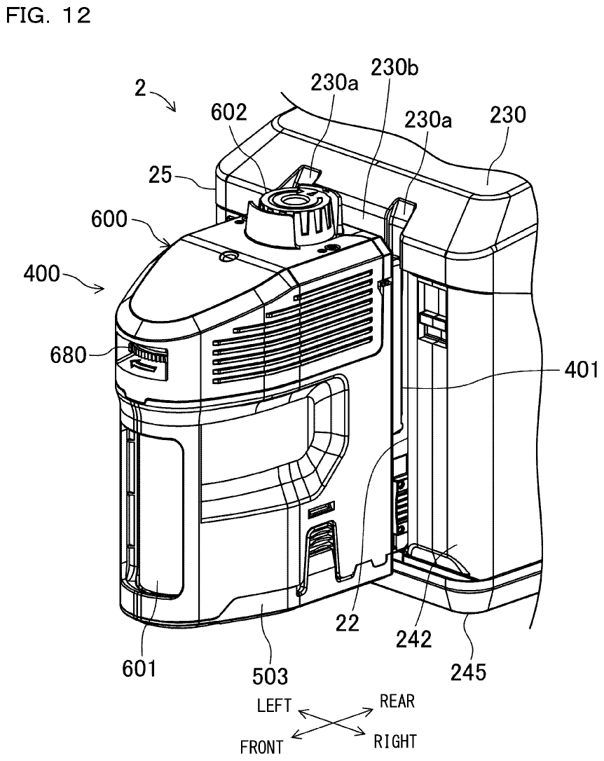

FIG. 12 is a perspective view illustrating a state in which the cleaning unit is attached to a front end surface of the print head;

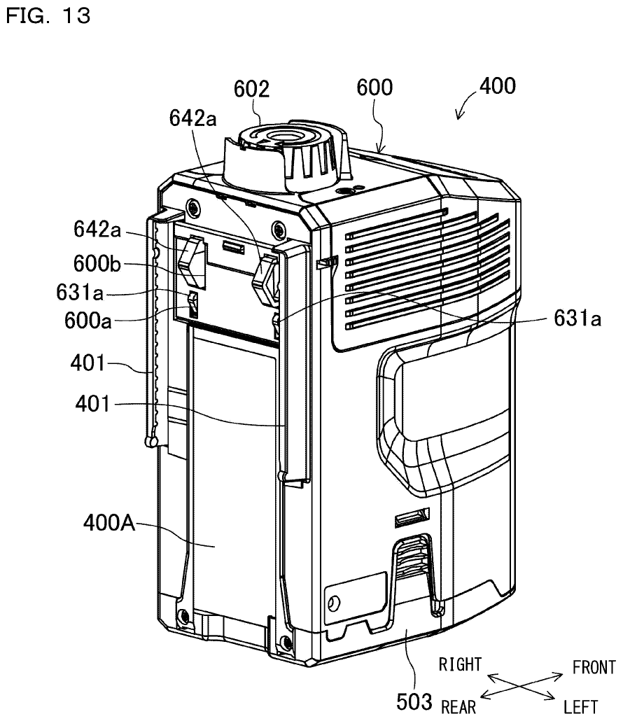

FIG. 13 is a perspective view of the cleaning unit as viewed from the rear;

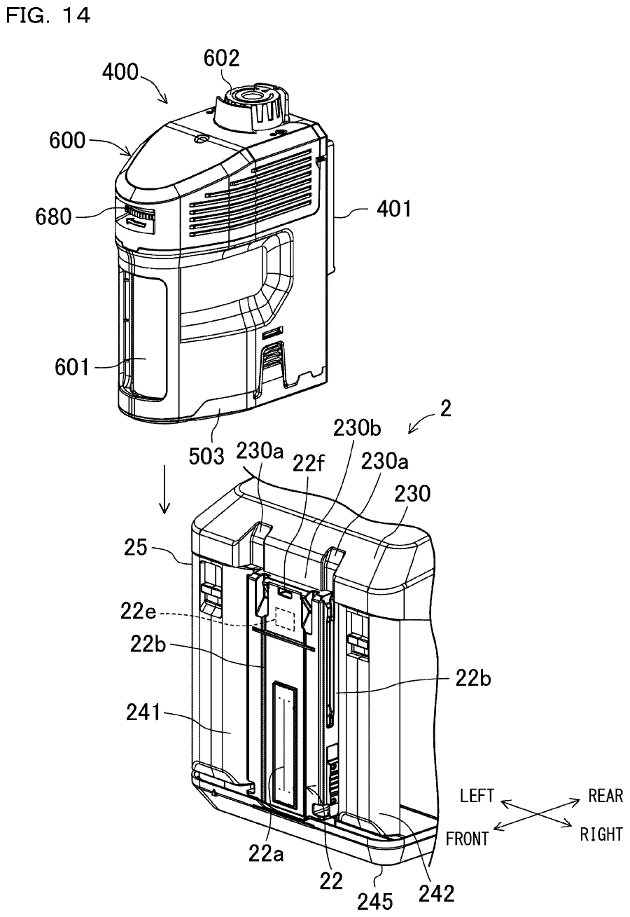

FIG. 14 is a view for describing a method of attaching the cleaning unit;

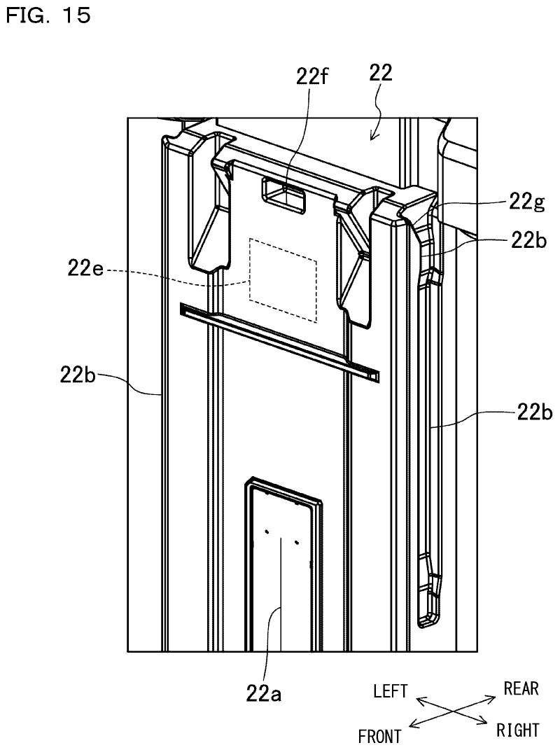

FIG. 15 is an enlarged view of the vicinity of an attachment groove of the print head;

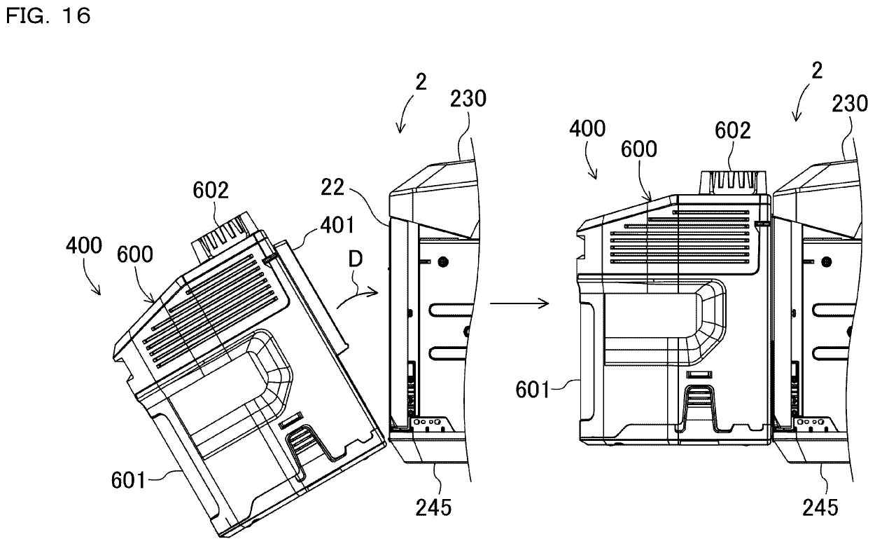

FIG. 16 is a side view illustrating Modification 1 of the attachment of the print head;

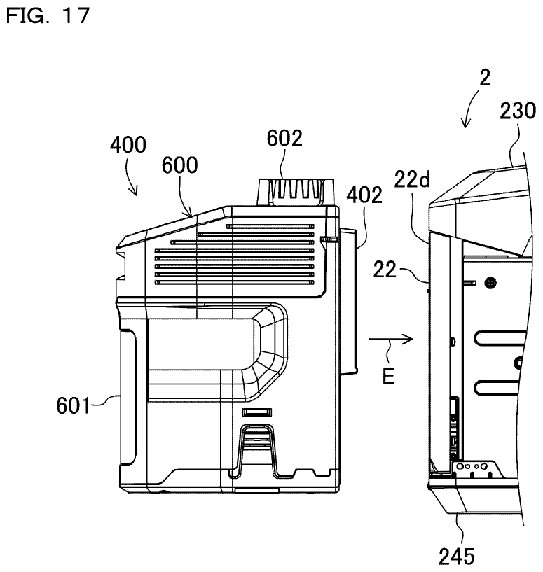

FIG. 17 is a side view illustrating Modification 2 of the attachment of the print head;

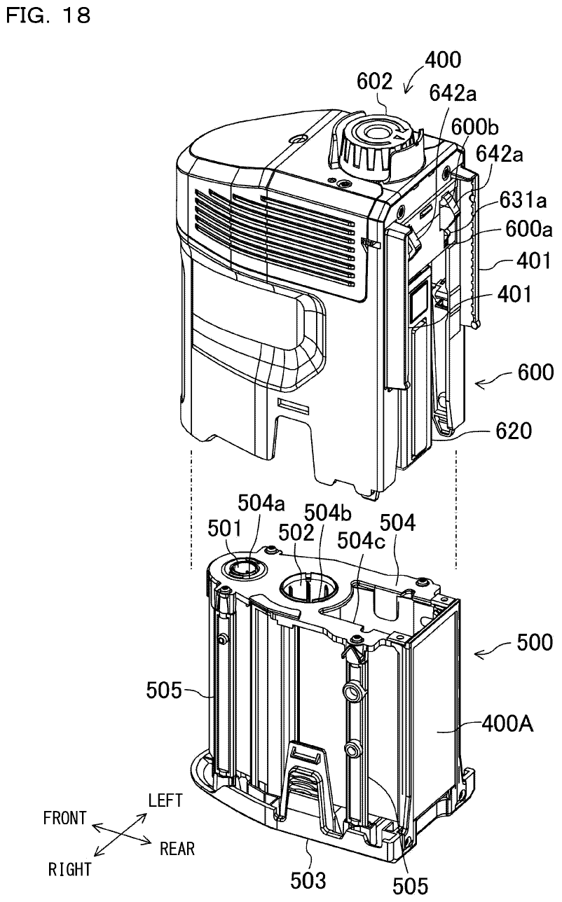

FIG. 18 is a perspective view illustrating a state in which a cleaning cartridge is taken out from a housing;

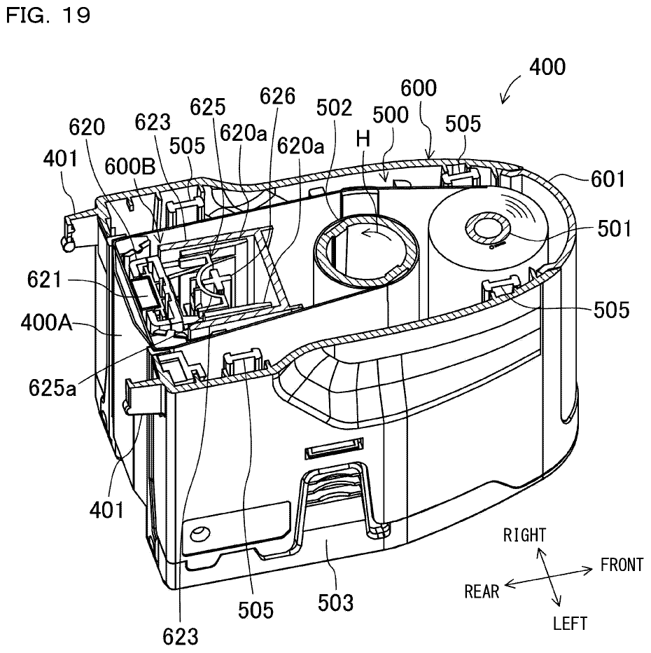

FIG. 19 is a cross-sectional view taken along line XIX-XIX in FIG. 11;

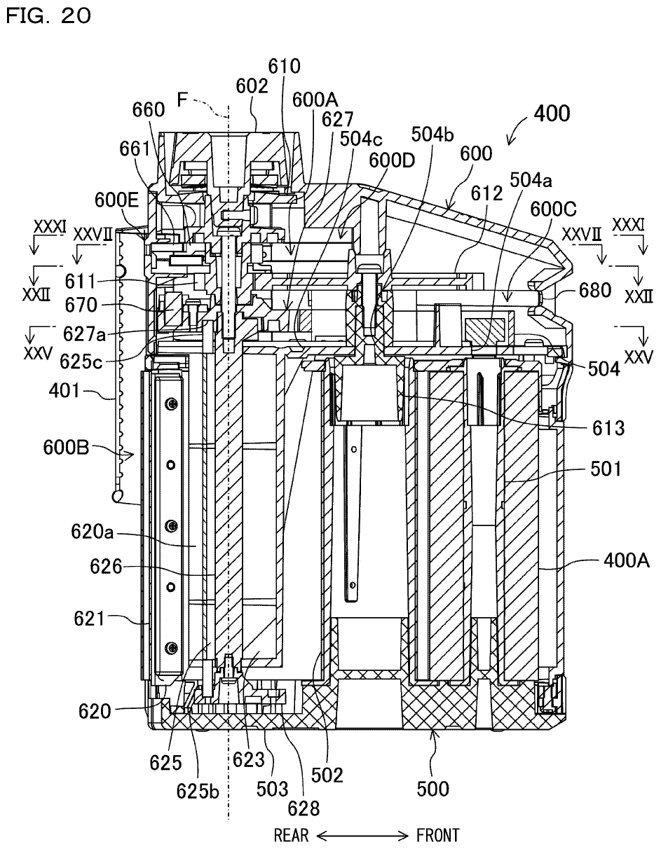

FIG. 20 is a cross-sectional view taken along line XX-XX in FIG. 11;

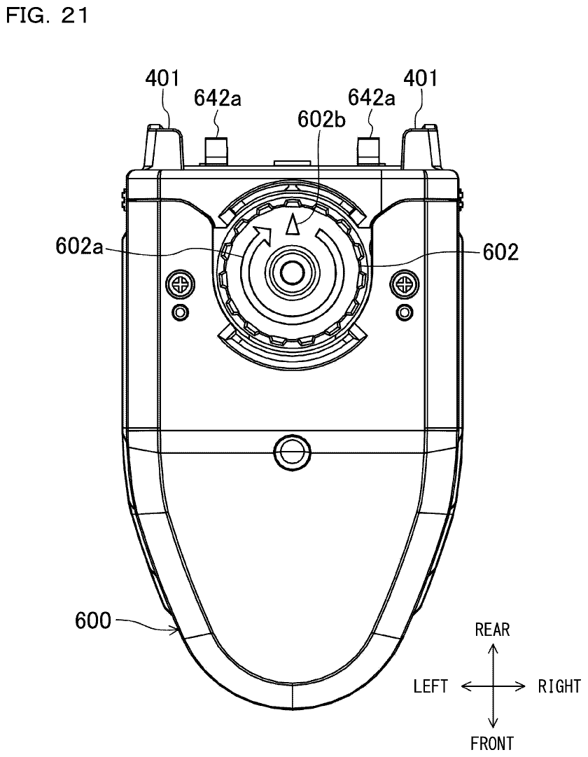

FIG. 21 is a plan view of the cleaning unit;

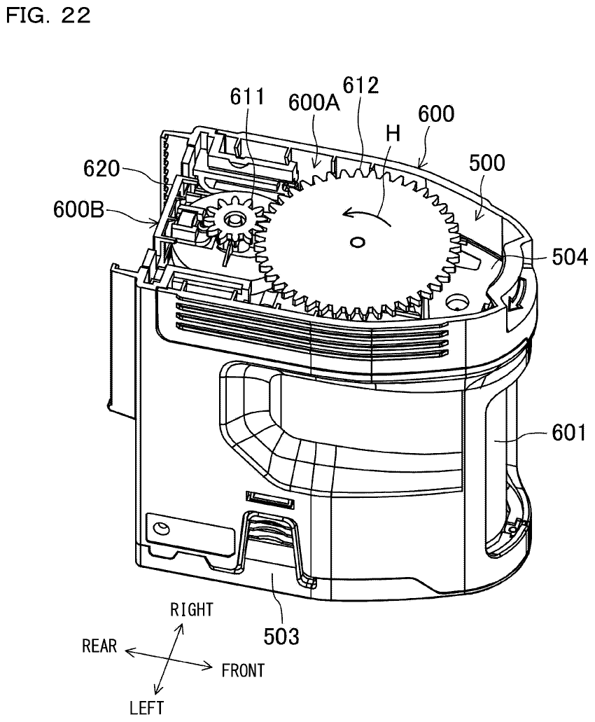

FIG. 22 is a cross-sectional view taken along line XXII-XXII in FIG. 20;

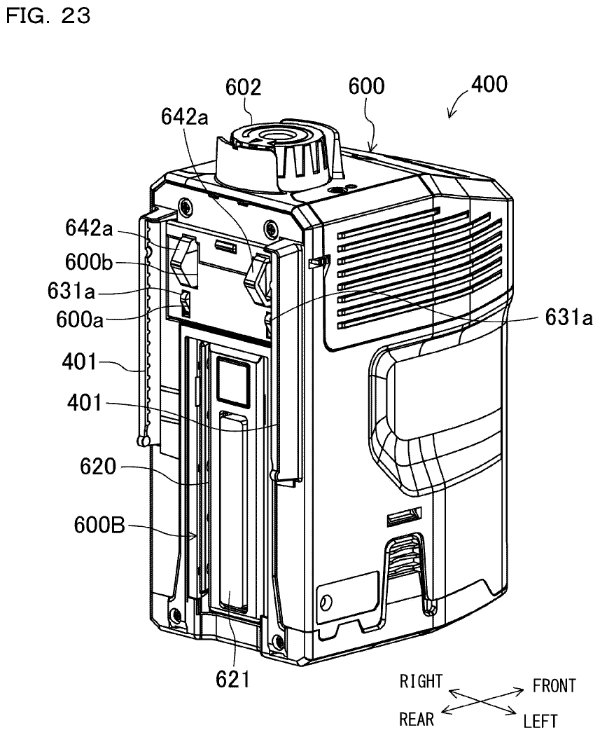

FIG. 23 is a view corresponding to FIG. 13 illustrating a state where a wiping member is detached;

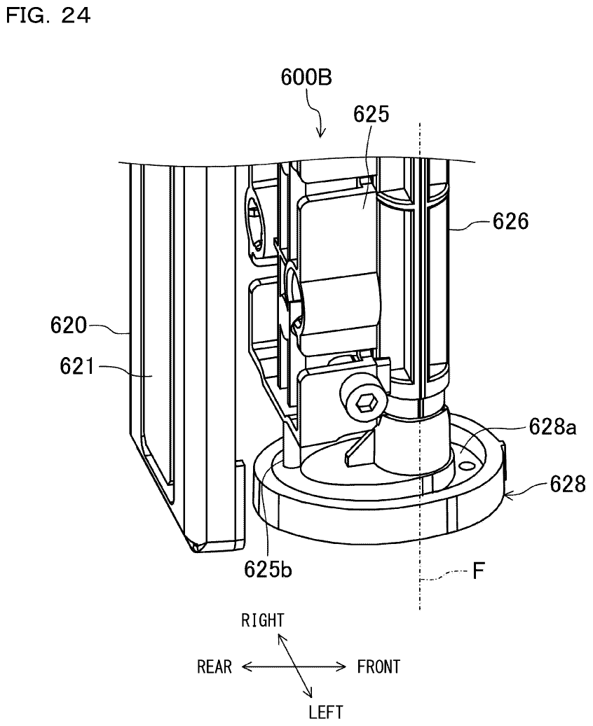

FIG. 24 is a perspective view illustrating a positional relationship among a bumper member, an input member, an input shaft, and a cam plate;

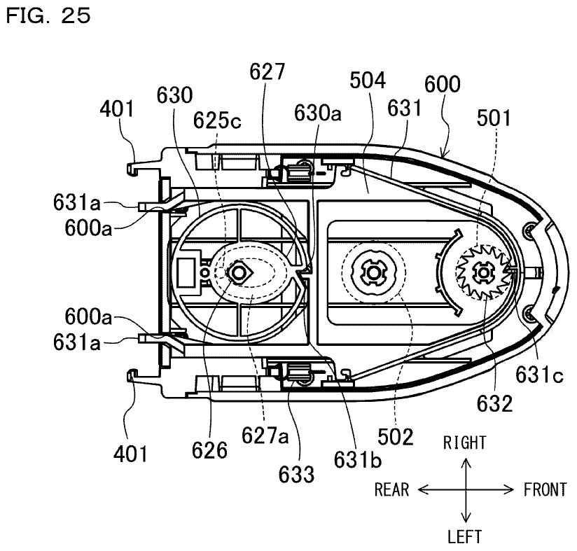

FIG. 25 is a cross-sectional view taken along line XXV-XXV in FIG. 20 and illustrates a case where a first lock mechanism is in a locked state;

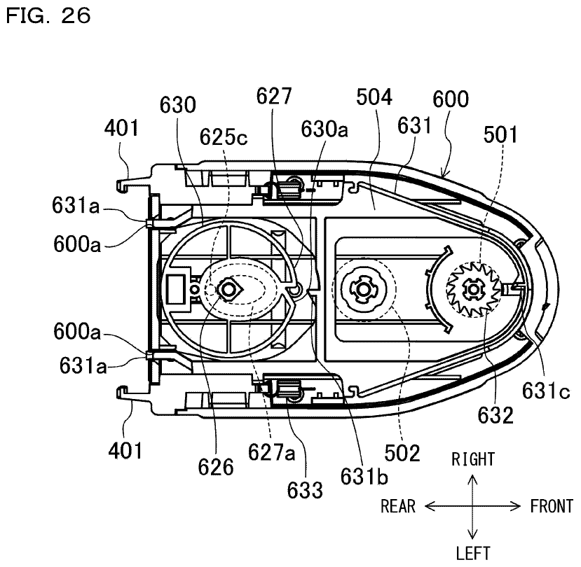

FIG. 26 is a view corresponding to FIG. 25 illustrating a case where the first lock mechanism is in a released state;

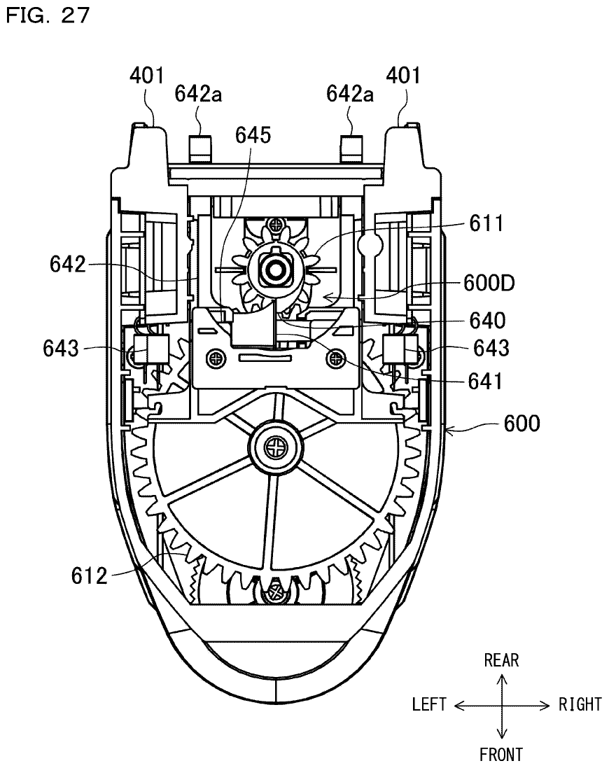

FIG. 27 is a cross-sectional view taken along line XXVII-XXVII in FIG. 20 and illustrates a case where a second lock mechanism is in a locked state;

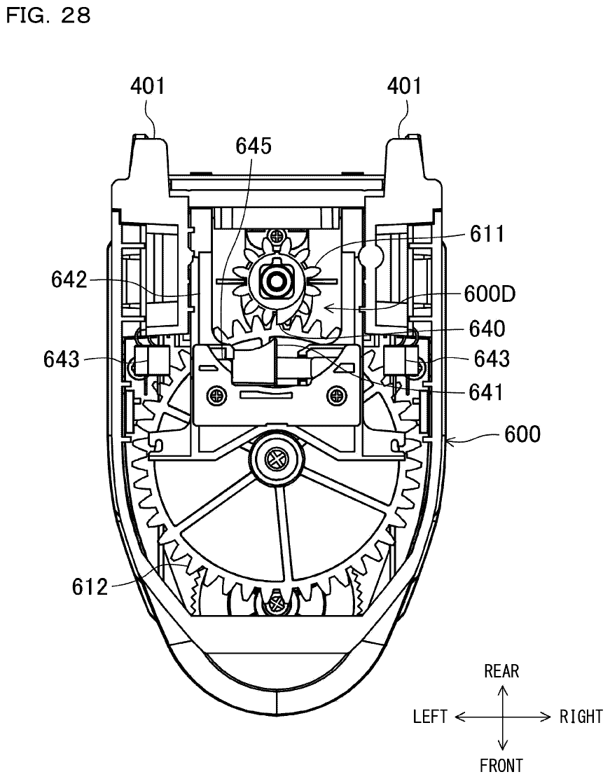

FIG. 28 is a view corresponding to FIG. 27 illustrating a case where the second lock mechanism is being released;

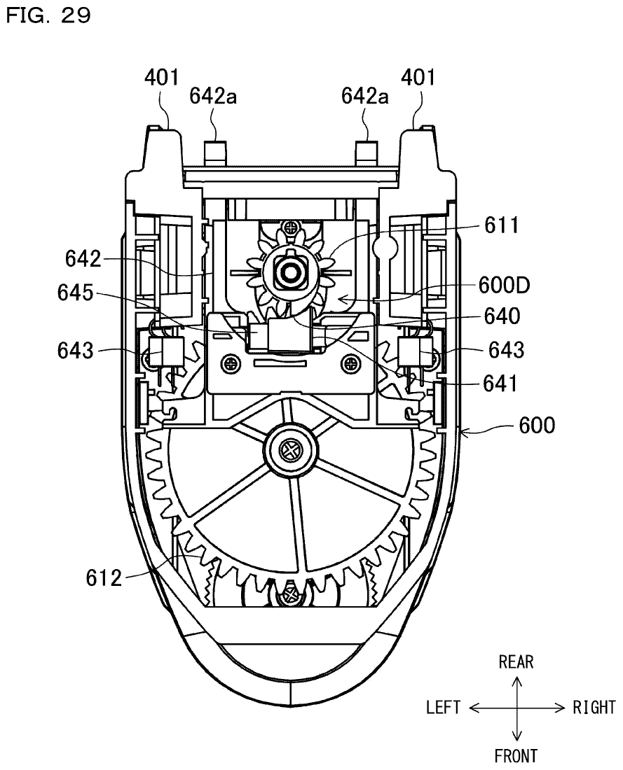

FIG. 29 is a view corresponding to FIG. 27 illustrating a case where the second lock mechanism is released;

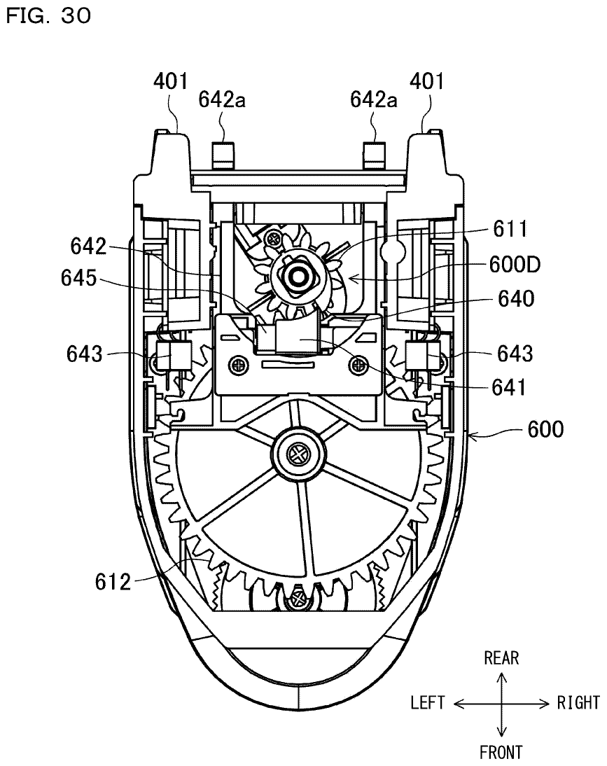

FIG. 30 is a view corresponding to FIG. 27 illustrating a case where the second lock mechanism is being locked;

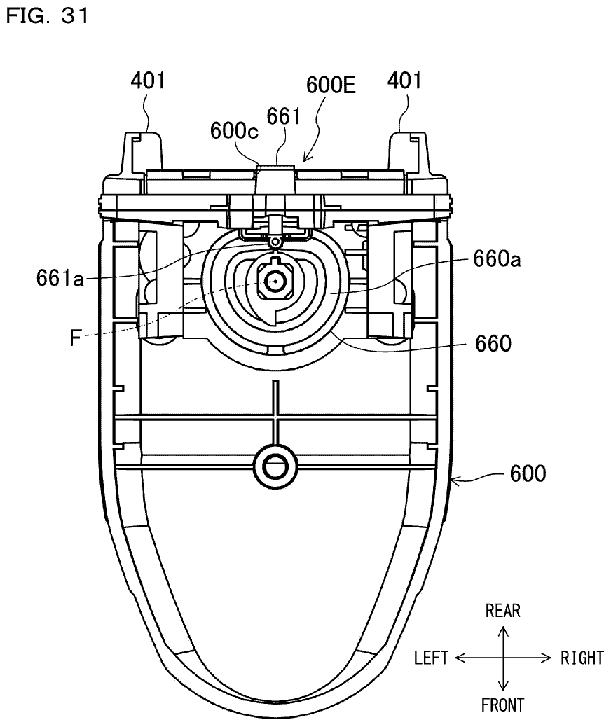

FIG. 31 is a cross-sectional view taken along line XXXI-XXXI in FIG. 20 and illustrates a case where the third lock mechanism is in an unlocked state; and

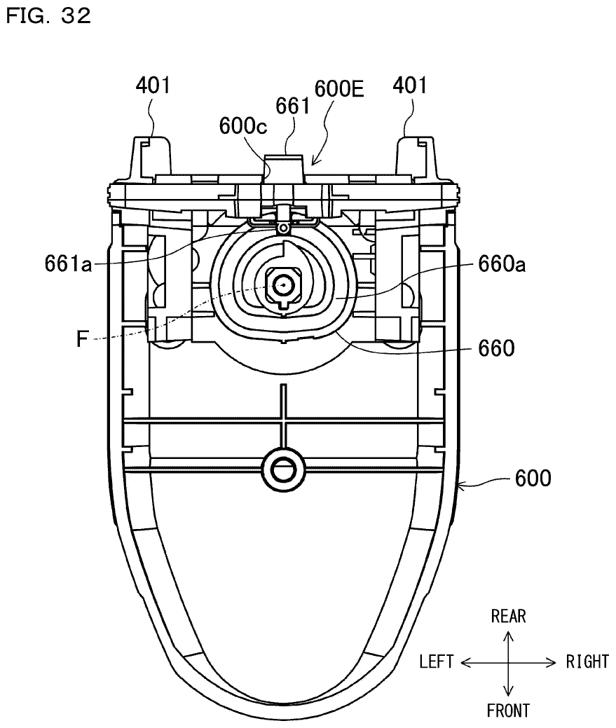

FIG. 32 is a view corresponding to FIG. 31 illustrating a case where a third lock mechanism is in a locked state.

### DETAILED DESCRIPTION

Hereinafter, embodiments of the present invention will be described in detail with reference to the drawings. Note that the following description of preferred embodiments is merely exemplary in nature, and is not intended to limit the present invention, its application, or its use.

FIG. 1 is a diagram schematically illustrating an overall configuration at the time of operation of an inkjet print apparatus 1 including a drawing machine 2 according to an embodiment of the present invention, and FIG. 2 is a block diagram of the inkjet print apparatus 1. The inkjet print apparatus 1 includes, for example, a drawing machine 2, an inspection machine 3, a controller 4, and an operation terminal 5.

The drawing machine 2 is a part that performs drawing processing on an object to be drawn, and is configured separately from the controller 4. The inspection machine 3 is a part that determines the quality of the drawing state executed on the object to be drawn by the drawing machine 2, and is configured separately from the controller 4. Since the inkjet print apparatus 1 according to the present embodiment includes the drawing machine 2 and the inspection machine 3, the inkjet print apparatus 1 is an inkjet print apparatus that ejects ink for drawing information onto an object and determines the quality of a drawing state by imaging.

The controller 4 is a part that controls the drawing machine 2 and the inspection machine 3, and can also be referred to as a control device, a control unit, or the like.

Furthermore, the operation terminal 5 includes a personal computer or the like, and is a part where a user inputs drawing information, performs various settings, selects, confirms, and the like, for example. The operation terminal 5 includes a terminal-side display section 5a including, for example, a liquid crystal display, and a terminal-side operation section 5b including a keyboard, a mouse, a pointing device, and the like.

The above configuration example is an example, and the present invention is not limited to the above configuration example. That is, the controller 4 may be incorporated into the operation terminal 5 or may be incorporated into the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. A control signal output from the external equipment 6 is input to the controller 4. The external equipment 6 may be equipment constituting a part of the inkjet print apparatus 1, or may be equipment different from the inkjet print apparatus 1.

The inkjet print apparatus 1 is an apparatus for forming a drawing pattern on a workpiece W (an example of a drawing object) conveyed in a horizontal direction by a conveyor (an example of a conveyance device) 10, and is an in-line apparatus used by being incorporated in a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the inkjet print apparatus 1, the plurality of workpieces W are sequentially conveyed in the direction of the arrow A illustrated in FIG. 1 in a state of being placed on a conveyance surface 10a of the conveyor 10. Therefore, the upstream side in the conveying direction is the left side in FIG. 1, and the downstream side in the conveying direction is the right side in FIG. 1. The plurality of workpieces W are placed on the conveyance surface 10a in a state of being spaced apart from each other in the direction of the arrow A which is the conveying direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The inkjet print apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the inkjet print apparatus 1 can also be referred to as a printing apparatus or the like, and the drawing machine 2 can also be referred to as a printing machine. Furthermore, the drawing of information by the inkjet print apparatus 1 also includes the case of printing an image or the like. In this case, the inkjet print apparatus 1 can be referred to as a print apparatus. In the following description, printing and printing are simply referred to as drawing.

Furthermore, an encoder 7 for detecting a position of the workpiece W, a detection sensor 9 to be described later, and the like are connected to the controller 4. The controller 4 detects the position of the workpiece W on the basis of signals output from the encoder 7 and the detection sensor 9. The controller 4 controls the drawing machine 2 so that drawing is started when the workpiece W arrives at a predetermined position.

### (Configuration of Drawing Machine 2)

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a DOD type drawing machine is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a drawing machine body 25 (illustrated in FIG. 1) provided with a print head 22. The drawing machine body 25 is fixed to the conveyor 10 or the like.

The print head 22 is accommodated and fixed inside the drawing machine body 25, and the positional relationship between the drawing machine body 25 and the print head 22 is fixed. Furthermore, the ink supply section 20 and the print head drive section 21 are also accommodated inside the drawing machine body 25.

The print head 22 of the DOD type drawing machine 2 is, for example, a member corresponding to an ejection section, and ejects ink supplied from the detachable ink cartridge 300 toward the workpiece W conveyed by the conveyor 10. The nozzle group 22a including a plurality of nozzles provided on the front end surface (one end face) of the print head 22 is arranged side by side in the direction of gravity, that is, the up-down direction.

A drawing pattern is formed on the workpiece W by the ink ejected from the nozzle group 22a of the print head 22. There are a plurality of types of structures of the print head 22, and for example, any of a thermal inkjet type, a valve jet type, and a piezo type may be used. In the present embodiment, a piezoelectric print head capable of performing low resolution to high resolution drawing, having a wide drawing width, and having high durability is used as the print head 22. The ink ejected from the print head 22 jumps from the drawing machine body 25 to the outside of the drawing machine body 25 and adheres to the workpiece W.

The ink supply section 20 is a section that supplies ink to the print head 22, and includes an ink tank 20a that accommodates ink to be supplied to the print head 22, and an ink cartridge 300 for replenishing ink to the ink tank 20a.

The print head drive section 21 is controlled by a control section 40 described later when performing the drawing operation. The print head drive section 21 generates a driving electric waveform for driving the print head 22 and outputs the driving electric waveform to the print head 22. The driving electric waveform is a waveform for individually driving the drive element (piezoelectric vibrator) provided for each ejection port of the print head 22 at a timing based on the drawing command output from the control section 40.

### (Configuration of Inspection Machine)

The inspection machine 3 is a device that determines whether the drawing state of the drawing pattern drawn on the workpiece W to be drawn is good or bad on the basis of the drawing data by using a captured image acquired by imaging the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

### (Integral Metal Fitting)

As illustrated in FIG. 1, the inkjet print apparatus 1 includes an integral metal fitting 90 for fixing the inspection machine 3 to the drawing machine body 25 that accommodates the print head 22. The integral metal fitting 90 includes a portion to which the drawing machine body 25 is attached and a portion to which the inspection machine 3 is attached. The integral metal fitting 90 has a predetermined dimension in the conveying direction of the workpiece W, and when the inspection machine 3 is fixed to the drawing machine body 25 by the integral metal fitting 90, the inspection machine 3 and the print head 22 can be in a positional relationship of being spaced apart from each other in the conveying direction of the workpiece W, that is, a fixed positional relationship. By fixing the inspection machine 3 to the drawing machine body 25 with the integral metal fitting 90, a relative fixed positional relationship with the print head 22 is defined.

FIG. 3 is a plan view illustrating an installation example of the drawing machine 2 and the inspection machine 3. In a case where the workpiece W is conveyed in the direction of the arrow A, the inspection machine 3 can be installed on the downstream side of the drawing machine 2 in the conveying direction of the workpiece W by providing the integral metal fitting 90 as indicated by the solid line. On the other hand, in a case where the workpiece W is conveyed in the direction of the arrow B opposite to the direction of the arrow A, the inspection machine 3 can be installed on the downstream side of the drawing machine 2 in the conveying direction of the workpiece W by providing the integral metal fitting 90 as indicated by a virtual line. In addition, by simultaneously providing the integral metal fitting indicated by a solid line and the integral metal fitting 90 indicated by a virtual line, it is possible to cope with both the direction of arrow A and the direction of arrow B.

FIG. 4 illustrates an installation example of the drawing machine 2 and the inspection machine 3, and is a view (front view) as viewed from a side where ink is ejected. As illustrated in FIG. 4, the inspection machine 3 is fixed to the drawing machine body 25 by the integral metal fitting 90 such that a center of the drawing area in the up-down direction and a center of the field of view of the imaging section 31 of the inspection machine 3 in the up-down direction have the same height.

### (Detection Sensor)

As illustrated in FIG. 1, the inkjet print apparatus 1 includes the detection sensor 9 that detects arrival of the workpiece W conveyed by the conveyor 10. The detection sensor 9 is installed on the upstream side of the drawing machine 2 in the conveying direction of the workpiece W. The detection sensor 9 is provided with, for example, an optical movement measurement sensor, a distance sensor, and the like (not illustrated), and these sensors can detect arrival of the conveyed workpiece W. When detecting the arrival of the workpiece W, the detection sensor 9 transmits a detection signal to the controller 4. The controller 4 determines that the workpiece W has arrived at a predetermined position on the basis of the detection signal output from the detection sensor 9, and causes the drawing machine 2 to start drawing after a predetermined drawing delay time has elapsed.

### (Configuration of Controller 4)

As illustrated in FIG. 2, the controller 4 includes a control section 40, a storage section 41, and an operation display section 42. The control section 40 includes, for example, a microcomputer including a central processing section, various memories, and the like, and can execute software stored in advance. The control section 40 is provided with a drawing setting section 40a, the drawing data generation section 40b, an inspection setting section 40c, a display screen generation section 40d, and a mode switching section 40e. The drawing setting section 40a, the drawing data generation section 40b, the inspection setting section 40c, the display screen generation section 40d, and the mode switching section 40e of the control section 40 are parts configured by hardware and software, and are described separately for convenience as the drawing setting section 40a, the drawing data generation section 40b, the inspection setting section 40c, the display screen generation section 40d, and the mode switching section 40e, but may be integrated in hardware.

The operation display section 42 includes a controller-side display section 42a including, for example, a liquid crystal display and a controller-side operation section 42b including operation keys and the like. The controller-side operation section 42b is a part that receives various operations such as drawing contents and settings. Various screens generated by the display screen generation section 40d are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type. Operation information of the touch panel by the user is transmitted to the control section 40.

The drawing setting section 40a is a part that sets a drawing content to be drawn on the workpiece W to be drawn. The drawing data generation section 40b is a part that defines ejection of ink in the print head 22 and generates drawing data corresponding to the drawing content set by the drawing setting section 40a. The control section 40 outputs a control signal to the print head drive section 21 on the basis of the drawing data generated by the drawing data generation section 40b, and controls ejection of ink from the ejection port of the print head 22.

The inspection setting section 40c is a part that performs inspection setting by the inspection machine 3. The storage section 41 is a part that stores a relative fixed positional relationship between the inspection machine 3 and the print head 22. The inspection setting section 40c supports the inspection setting by the user on the basis of the drawing content set by the drawing setting section 40a and the relative fixed positional relationship stored in the storage section 41.

### (Detailed Structure of Drawing Machine)

FIGS. 1 to 4 schematically illustrate the shapes of the drawing machine 2, the print head 22, the drawing machine body 25, the ink cartridge 300, and the like, but specific shapes of the drawing machine 2, the print head 22, the drawing machine body 25, the ink cartridge 300, and the like are as illustrated in each of FIG. 5 and subsequent drawings. The shapes illustrated in FIG. 5 and subsequent drawings and the shapes illustrated in FIGS. 1 to 4 may be partially different from each other, but the reason is that FIGS. 1 to 4 are drawings for conceptual description.

As illustrated in FIG. 5, the drawing machine body 25 includes a box-shaped housing 200 extending in the longitudinal direction. The ink tank 20a illustrated in FIG. 2 is provided inside the housing 200, and cannot be visually recognized from the outside. In the installation state of the drawing machine 2, the longitudinal direction of the housing 200 coincides with the width direction of the conveyor 10. In the present specification, a longitudinal direction of the housing 200 is defined as a front-rear direction, and a side facing the workpiece W at the time of installation is defined as a front side. Furthermore, a side located on the right when the drawing machine 2 is viewed from the front side is defined as the right side, a side located on the left when the drawing machine 2 is viewed from the front side is defined as the left side, and the left-right direction of the drawing machine 2 is defined as the width direction. The definition of the direction is a definition for convenience of description, and does not limit the direction according to the present invention.

As illustrated in FIG. 5, the housing 200 has a shape close to a rectangular parallelepiped that is long in the front-rear direction. Therefore, the dimension of the housing 200 in the front-rear direction is longer than the dimension of the housing 200 in the left-right direction and the dimension of the housing 200 in the up-down direction.

Since the housing 200 has a shape close to a rectangular parallelepiped, the outer peripheral surface of the housing 200 includes six surfaces. That is, the outer peripheral surface of the housing 200 includes a front surface 201 disposed to face the workpiece W, a rear surface 202 located on the opposite side of the front surface 201, a right side surface 203 located on the right when viewed from the direction facing the front surface 201, a left side surface 204 located on the left when viewed from the direction facing the front surface 201, an upper surface 205, and a lower surface 206. The front surface 201, the rear surface 202, the right side surface 203, and the left side surface 204 are surfaces constituting an outer side surface of the housing 200. One end face in the longitudinal direction of the outer side face of the housing 200 is a front surface 201, and the other end face in the longitudinal direction of the outer side surface of the housing 200 is a rear surface 202. The front surface 201 is provided with a print head 22 for ejecting ink toward the workpiece W being conveyed. Note that the front surface 201 may be referred to as a front surface or a back surface of the rear surface 202.

As illustrated in FIG. 5 and the like, the drawing machine 2 includes an upper cover 230 detachable from the drawing machine body 25. FIG. 6 illustrates a state in which the upper cover 230 is detached. The drawing machine 2 includes an absorber 240 (illustrated only in FIG. 6) for absorbing the ink leaking from the print head 22, and a casing 241 for accommodating the absorber 240. The absorber 240 is made of sponge, fiber, or the like.

The casing 241 has a shape elongated in the up-down direction, and is detachably provided on the left side of the print head 22 on the front surface 201 of the housing 200. FIG. 7 illustrates a state in which the casing 241 is detached from the drawing machine body 25 and moved forward. As illustrated in FIG. 7, only the casing 241 can be detached from the drawing machine body 25 and replaced without removing the upper cover 230.

The absorber 240 is provided only on one of the left side and the right side of the drawing machine body 25. In this example, since the casing 241 accommodating the absorber 240 is provided on the left side of the drawing machine body 25, the absorber 240 is not provided on the right side of the drawing machine body 25. Therefore, on the right side of the drawing machine body 25, a box-shaped member 242 that does not accommodate the absorber 240 is detachably provided. The shape of the box-shaped member 242 is bilaterally symmetrical with the casing 241. Note that, in a case where the absorber 240 is provided on the left side of the drawing machine body 25, the casing 241 accommodating the absorber 240 may be detachably provided on the left side of the drawing machine body 25, and the box-shaped member 242 may be detachably provided on the right side.

A tray 245 having a liquid feeding structure for guiding the ink leaking from the print head 22 to the absorber 240 is provided below the print head 22 in the drawing machine body 25. The tray 245 is detachably provided below the nozzle group 22a on a front surface 201 of the drawing machine body 25. FIG. 8 illustrates a state in which the casing 241, the box-shaped member 242, and the tray 245 are detached from the drawing machine body 25, and the tray 245 is moved forward.

As illustrated in FIG. 9, the tray 245 is formed so as to extend to the left side and the right side below the print head 22, and has a concave shape that opens upward as a whole. The casing 241 accommodating the absorber 240 is located above the left side of the tray 245, while the box-shaped member 242 is located above the right side of the tray 245. As illustrated in FIG. 10, the bottom surface 245a of the tray 245 is inclined downward toward the left side from the center in the left-right direction. As a result, the ink leaking from the print head 22 can be received by the bottom surface 245a of the tray 245 and then flowed to the left side, that is, the side where the absorber 240 is provided, so the ink can be reliably absorbed by the absorber 240. Note that, in a case where the absorber 240 is provided on the right side, the tray 245 with the bottom surface 245a inclined in the opposite direction may be attached.

FIG. 9 illustrates a positional relationship between the ink tank 20a and the print head 22. The ink tank 20a is installed in a lower portion of the drawing machine body 25. As illustrated in FIG. 9, the ink tank 20a is formed so as to be disposed behind the print head 22 and on the left side and the right side of the print head 22 in plan view, and is not disposed in front of the print head 22. That is, the ink tank 20a of the present embodiment is provided so as to surround a portion other than the side having the nozzle group 22a in the print head 22 in plan view.

As illustrated in FIG. 6, the drawing machine 2 includes an operation button 250. The operation button 250 is a member that receives a user instruction for controlling the drawing machine 2. The number of operation buttons 250 may be one or two or more. The operation button 250 is provided on the upper portion of the rear surface 202 of the housing 200 and is located on the side opposite to the print head 22 side. As a result, the user can operate the operation button 250 from the side opposite to the conveyor 10, and thus operability is improved. Examples of the operation button 250 include a test button to be operated in a case where test drawing is performed, a cleaning button to be operated in a case where the drawing machine 2 is cleaned, and the like, but the operation button may be a button to execute any function.

The drawing machine 2 includes a waste liquid bottle 251. A waste liquid bottle 251 is used as a collection tank that collects ink, is provided on the rear surface 202 of the housing 200, and is located on the side opposite to the print head 22 side. The waste liquid bottle 251 is a container for storing ink that has been supplied from the ink tank 20a to the print head 22 and has not been ejected toward the workpiece W. An ink inflow port (not illustrated), which is an opening of the waste liquid bottle 251, is provided in the upper portion of the waste liquid bottle 251, and is formed at a position higher than the liquid level of the ink accommodated in the ink tank 20a (illustrated in FIG. 9). The ink that has been supplied to the print head 22 and has not been ejected toward the workpiece W is fed to the opening of the waste liquid bottle 251 by the feeder, and then flows into the waste liquid bottle 251 from the opening. The waste liquid bottle 251 is configured to be detachable from the drawing machine body 25, and can discharge ink in the waste liquid bottle 251 as necessary.

Furthermore, as illustrated in a state where the upper cover 230 is detached in FIG. 6, an air filter 260 for filtering air sucked into the drawing machine body 25, a level 261, and a hand valve 262 for opening and closing an internal pipeline by manual operation are provided on the upper side of the drawing machine body 25. The air filter 260, the level 261, and the hand valve 262 are arranged in the front-rear direction. When the upper cover 230 is attached to the drawing machine body 25, the air filter 260, the level 261, and the hand valve 262 are covered by the upper cover 230 and cannot be seen from the outside.

The drawing machine 2 includes a purge control section 27. The purge control section 27 is a portion that executes a purge process of leaking the ink remaining in the flow path from the ink tank 20a to the nozzle group 22a to the outside through the nozzle group 22a. For example, by pressurizing the inside of the ink tank 20a, the ink remaining in the flow path from the ink tank 20a to the nozzle group 22a can be sent to the nozzle group 22a and leaked to the outside from the nozzle group 22a. Such a purge process is executed, for example, at the time of maintenance of the drawing machine 2. The maintenance of the drawing machine 2 is started by receiving a maintenance execution instruction from the user. The purge control section 27 may be provided in the drawing machine body 25, or may be provided outside the drawing machine body 25 separately from the drawing machine body 25. For example, the purge control section 27 may be incorporated in the controller 4, and in this case, the purge control section 27 of the controller 4 executes the purge process.

By executing the purge process, the ink leaking from the nozzle group 22a flows downward. Since the tray 245 is provided below the nozzle group 22a, the ink leaking from the nozzle group 22a by the purge process can be received by the tray 245. The ink received by the tray 245 is guided to the absorber 240 by the tray 245 and absorbed by the absorber 240.

### (Cleaning Unit)

Residual ink may adhere to the nozzle group 22a of the print head 22. Furthermore, since the nozzle group 22a of the print head 22 is exposed to the outside, dust, dirt and the like may adhere to the nozzle group 22a. Remaining ink, dust, dirt, and the like are adhering matters adhered to the nozzle group 22a. Since the adhering matter is dirt on the nozzle group 22a, if the adhering matter remains attached to the nozzle group 22a, the drawing quality deteriorates.

Therefore, it is necessary to remove the adhering matters. The drawing machine 2 of the present embodiment includes a cleaning unit 400 (illustrated in FIG. 11) for wiping off and cleaning off adhering matters on the nozzle group 22a at the time of maintenance. The cleaning unit 400 is configured to be able to remove adhering matters by manual operation by a user, and does not need to incorporate a power source such as a battery, and does not need to supply power from the outside.

As illustrated in FIG. 12, the cleaning unit 400 is positioned with respect to the nozzle group 22a in a state of being detachably attached to the front end surface of the print head 22.

Based on the state of being attached to the print head 22, as illustrated in each drawing, the front side, the rear side, the left side, and the right side of the cleaning unit 400 are defined. The direction of the cleaning unit 400 corresponds to the direction of the drawing machine body 25. The front side and the rear side of the drawing machine body 25 correspond to the front side and the rear side of the cleaning unit 400, respectively. The right side and the left side of the drawing machine body 25 correspond to the right side and the left side of the cleaning unit 400, respectively. Note that the cleaning unit 400 may be positioned with respect to the nozzle group 22a in all of the up-down direction, the front-rear direction, and the left-right direction, but may be positioned at least in the front-rear direction.

The cleaning unit 400 is attached to the front end surface of the print head 22 only at the time of maintenance of the drawing machine 2. As a result, the cleaning unit 400 can abut on the front surface 201 of the print head 22. During operation of the drawing machine 2, the cleaning unit 400 is detached from the front end surface of the print head 22. The maintenance includes at least a process of removing adhering matters of the nozzle group 22a, and may include other cleaning processes and inspections. At the time of maintenance of the drawing machine 2, the cleaning unit 400 can be attached to the front end surface of the print head 22 without moving the drawing machine 2 from the installation position at the time of operation to remove adhering matters. Note that, at the time of maintenance of the drawing machine 2, the cleaning unit 400 may be attached to the front end surface of the print head 22 after the drawing machine 2 is moved from the installation position at the time of operation.

As illustrated in FIG. 13, the cleaning unit 400 includes a wiping member 400A for wiping off the adhering matter adhered to the nozzle group 22a by the purge process by the purge control section 27. The wiping member 400A includes, for example, a nonwoven fabric and has softness and flexibility. The dimension of the wiping member 400A in the up-down direction is set to be larger than or equal to the dimension from the upper end portion to the lower end portion of the nozzle group 22a.

When the cleaning unit 400 is positioned on the front end surface of the print head 22, the position in the height direction of the wiping member 400A becomes the same as the position in the height direction of the nozzle group 22a, and the wiping member 400A and the nozzle group 22a become the same as the position in the left-right direction. As a result, the adhering matters adhered to all the nozzles constituting the nozzle group 22a can be wiped off with the common wiping member 400A. As described above, since the wiping member 400A is positioned at least in the front-rear direction with respect to the housing 600 of the cleaning unit 400, positioning in the front-rear direction between the nozzle group 22a formed on the front end surface of the print head 22 and the wiping member 400A is performed by positioning the cleaning unit 400 at least in the front-rear direction with respect to the front end surface of the print head 22.

An example of a detachable structure of the cleaning unit 400 with respect to the print head 22 will be described. FIG. 14 illustrates the cleaning unit 400 separated from the print head 22. As illustrated in FIG. 14, attachment grooves (sliding portions) 22b extending in the arrangement direction of the nozzle groups 22a are formed in the right side portion and the left side portion of the front end surface of the print head 22, respectively. Furthermore, the attachment groove 22b is open to the front side. As illustrated in an enlarged view in FIG. 15, a ridge 22c extending in the up-down direction is formed in an open portion of the attachment groove 22b. A guide surface 22g inclined so as to be located on the front side as going upward is formed at the upper end of the ridge 22c. The upper end of the attachment groove 22b is open upward. As illustrated in FIG. 14, a recess 230a is formed above the attachment groove 22b on the front end surface of the upper cover 230.

As illustrated in FIG. 13, rail portions 401 to be inserted into the attachment grooves 22b of the print head 22 are formed on the right side portion and the left side portion of the rear surface of the cleaning unit 400, respectively, so as to extend in the up-down direction. The interval between the left and right rail portions 401 is set to be the same as the interval between the attachment grooves 22b of the print head 22. The rail portion 401 protrudes rearward from the rear surface of the cleaning unit 400. The rail portion 401 is an example of an attachment portion that is detachably attached to the front end surface of the print head 22 in which the nozzle group 22a is arranged and positions the wiping member 400A with respect to the nozzle group 22a.

That is, when the cleaning unit 400 is attached to the print head 22, as illustrated in FIG. 14, the cleaning unit 400 is disposed above the print head 22 and then moved in the downward arrow direction, and the lower end portions of the left and right rail portions 401 of the cleaning unit 400 are inserted into the attachment grooves 22b from the open portions of the upper end portions of the left and right attachment grooves 22b of the print head 22. At this time, since the recess 230a is formed on the front end surface of the upper cover 230, the rail portion 401 of the cleaning unit 400 does not interfere with the upper cover 230. Furthermore, since the guide surface 22g (illustrated in FIG. 15) is formed at the upper end portion of the ridge 22c of the print head 22, the rail portion 401 of the cleaning unit 400 can be easily inserted into the attachment groove 22b of the print head 22.

When the cleaning unit 400 is further moved in the arrow direction after the rail portion 401 is inserted into the attachment groove 22b, the rail portion 401 of the cleaning unit 400 slides with respect to the inner surface of the attachment groove 22b and the ridge 22c of the print head 22. When the cleaning unit 400 moves in the arrow direction until the wiping member 400A reaches the same height as the height of the nozzle group 22a and the wiping member 400A reaches the same height as the height of the nozzle group 22a, the rail portion 401 of the cleaning unit 400 abuts on a stopper (not illustrated) provided on the print head 22 from above, and the cleaning unit 400 is positioned in the height direction. Furthermore, when the rail portion 401 is inserted into the attachment groove 22b, the rail portion 401 is engaged with the ridge 22c, and the displacement of the cleaning unit 400 in the left-right direction and the displacement in the front-rear direction with respect to the print head 22 are regulated. This positions the cleaning unit 400 relative to the print head 22. As described above, the cleaning unit 400 is attached by the user manually sliding the cleaning unit in the arrangement direction of the nozzle group 22a with respect to the inner surface of the attachment groove 22b and the ridge 22c of the print head 22. That is, the cleaning unit 400 is held in a state of abutting on the front surface 201 of the print head 22, and the cleaning unit 400 is positioned with respect to the print head 22 in the abutment state. On the other hand, when detaching the cleaning unit 400, the cleaning unit is moved upward with respect to the print head 22, and the rail portion 401 is detached from the attachment groove 22b.

Note that, although not illustrated, when the cleaning unit 400 is attached to the print head 22, the cleaning unit 400 may be moved from one side to the other side in the left-right direction of the print head 22 to be attached. In this case, the rail 401 and the attachment groove 22b may have a shape extending in the left-right direction.

The structure of attaching the cleaning unit 400 to the print head 22 through manual operation by the user is not limited to the above-described structure. For example, as in Modification 1 illustrated in FIG. 16, after the user manually attaches the lower portion of the cleaning unit 400 to the lower portion of the print head 22, the cleaning unit 400 may be rotated in the direction of the arrow D, and then the upper portion of the cleaning unit 400 may be lifted to fit the rail portion 401 to the ridge 22c. In a state where the rail portion 401 is fitted to the ridge 22c, the cleaning unit 400 is held in a state of abutting on the front surface 201 of the print head 22, and in the abutment state, the cleaning unit 400 is positioned with respect to the print head 22.

Furthermore, as in Modification 2 illustrated in FIG. 17, the cleaning unit-side magnet 402 and the head-side magnet 22d may be provided in the rear side portion of the cleaning unit 400 and the front side portion of the print head 22, respectively, and the cleaning unit 400 may be attached to the print head 22 using a magnetic force of the cleaning unit-side magnet 402 and the head-side magnet 22d. The cleaning unit-side magnet 402 and the head-side magnet 22d are permanent magnets, and the directions of magnetic poles are set so as to attract each other. In the case of this Modification 2, after disposing the cleaning unit 400 in front of the print head 22, when the user manually moves the cleaning unit 400 close to a direction of the arrow E, the cleaning unit 400 can be attached to the print head 22 by a mutual attraction force of the cleaning unit-side magnet 402 and the head-side magnet 22d. In a state where the cleaning unit 400 is attached to the print head 22 by the mutual attraction force of the cleaning unit-side magnet 402 and the head-side magnet 22d, the cleaning unit 400 is held in a state of abutting on the front surface 201 of the print head 22, and in the abutment state, the cleaning unit 400 is positioned with respect to the print head 22.

As a further modification, not illustrated, the cleaning unit 400 can be brought into abutment against the front surface 201 of the print head 22 by a user pressing the cleaning unit 400 against the front surface 201 of the print head 22 while holding the cleaning unit by hand.

Even in this case, since the wiping member 400A is positioned with respect to the housing 600 of the cleaning unit 400, the wiping member 400A is positioned with respect to the nozzle group 22a formed on the front surface 201 of the print head 22 in a state where the cleaning unit 400 abuts on the front surface 201 of the print head 22. In a case where the cleaning unit 400 is pressed and abutted by the user, the cleaning unit 400 is not held against the print head 22, so that the user needs to support and use the cleaning unit, but a structure for attaching the cleaning unit 400 to the print head 22 is not required, so that the design is facilitated and the manufacturing cost is also reduced.

As illustrated in FIG. 18, the cleaning unit 400 includes a cleaning cartridge 500 and a housing 600 that accommodates the cleaning cartridge 500. A lower portion of the housing 600 is opened, and the cleaning cartridge 500 can be accommodated in the housing 600 from below.

As also illustrated in FIG. 19, the cleaning cartridge 500 includes a wiping member 400A, a hollow driven shaft 501 around which the wiping member 400A before use is wound, and a hollow drive shaft (winding shaft) 502 for winding the wiping member 400A after use.

The driven shaft 501 is disposed in a front portion of the cleaning cartridge 500 and extends in the up-down direction. An upper end portion and a lower end portion of the driven shaft 501 are opened. The drive shaft 502 is disposed in an intermediate portion of the cleaning cartridge 500 in the front-rear direction, and extends in the up-down direction substantially parallel to the driven shaft 501. An upper end portion and a lower end portion of the drive shaft 502 are opened.

The wiping member 400A has an elongated shape and has a length capable of wiping off adhering matters on the nozzle group 22a many times. The wiping member 400A before use is wound around the driven shaft 501 in advance, whereby the driven shaft 501 has a roll shape. When all the wiping members 400A wound around the driven shaft 501 are used, all the wiping members 400A are detached from the driven shaft 501 and wound around the drive shaft 502, taken out from the housing 600 as the used cleaning cartridge 500, and then discarded. Thereafter, the cleaning unit 400 can be used by preparing a new cleaning cartridge 500 and accommodating the cleaning cartridge in the housing 600. In this way, the cleaning cartridge 500 is replaceable while the housing 600 side is reusable.

As illustrated in FIG. 18, the cleaning cartridge 500 includes a bottom plate portion 503 that rotatably supports the lower end portion of the driven shaft 501 and the lower end portion of the drive shaft 502, and an upper plate portion 504 that rotatably supports the upper end portion of the driven shaft 501 and the upper end portion of the drive shaft 502. As illustrated in FIG. 19, the bottom plate portion 503 is disposed so as to face the outside from the lower portion of the housing 600, and functions as a lid that closes the open portion of the housing 600.

In the upper plate portion 504, a driven-side opening 504a is formed in a portion supporting the upper end portion of the driven shaft 501, and a drive-side opening 504b is formed in a portion supporting the upper end portion of the drive shaft 502. Furthermore, a rear opening 504c is formed in a rear portion of the upper plate portion 504 than the drive-side opening 504b.

The cleaning cartridge 500 includes a coupling member 505 that couples the bottom plate portion 503 and the upper plate portion 504. The coupling member 505 extends in the up-down direction, and has an upper portion fixed to the peripheral edge portion of the upper plate portion 504 and a lower portion fixed to the peripheral edge portion of the bottom plate portion 503. In the present embodiment, as illustrated in FIG. 19, a plurality of the coupling members 505 are provided at intervals in the circumferential direction of the upper plate portion 504 and the bottom plate portion 503.

As illustrated in FIGS. 19 and 20, a window portion 601 having a light-transmissive member is provided in a front portion of the housing 600. The wiping member 400A before use is wound around the driven shaft 501 in advance to form a roll shape, and the driven shaft 501 is provided in the front portion of the cleaning cartridge 500, so that the roll-shaped member can be visually recognized through the window portion 601. As a result, the process in which the wiping member 400A is used and the roll is reduced can be visually recognized from the outside of the housing 600 through the window portion 601, so that the user can grasp the remaining amount of the wiping member 400A without taking out the cleaning cartridge 500 from the housing 600. Furthermore, when all the wiping members 400A are used and wound around the drive shaft 502, the outer peripheral surface of the driven shaft 501 is visible from the outside of the housing 600 through the window portion 601. As a result, the user can grasp that the wiping member 400A before use has run out without taking out the cleaning cartridge 500 from the housing 600. Note that the color of the wiping member 400A may be different from the color of the outer peripheral surface of the driven shaft 501. For example, when the color of the wiping member 400A is white and the color of the outer peripheral surface of the driven shaft 501 is red, the white member is visible from the window portion 601 in a state where the wiping member 400A remains, but the red member is visible from the window portion 601 when the wiping member 400A disappears. As a result, the user can easily grasp that the wiping member 400A has run out.

As illustrated in FIG. 18, an operation section 602 for performing a feeding operation of the wiping member 400A is provided in an upper portion on the rear side of the housing 600. The operation section 602 is a rotary knob that protrudes upward from the upper surface of the housing 600 and can be held and rotated by a user's finger. As illustrated in FIG. 20, the lower portion of the operation section 602 is rotatably supported around a shaft F extending in the up-down direction with respect to the housing 600. Unlike the driven shaft 501 and the drive shaft 502, the shaft F is virtually illustrated. The shaft F and the driven shaft 501 and the drive shaft 502 have a parallel relationship.

As illustrated in FIG. 21, on the upper surface of the operation section 602, a direction display section 602a indicating the rotation direction of the operation section 602 and a stop position display section 602b indicating the stop position of the operation section 602 are provided. The direction display section 602a includes, for example, an arrow or the like. The stop position display section 602b indicates to the user that the operation section 602 is rotated until the stop position display section 602b comes to a predetermined position, and is provided only in a part of the operation section 602 in the circumferential direction.

As illustrated in FIG. 20, a reverse rotation prevention structure 610 for preventing reverse rotation of the operation section 602 is provided in a lower portion of the operation section 602. The reverse rotation prevention structure 610 includes, for example, a running surface. The running surface includes, on the lower surface of the operation section 602, a plurality of movable teeth (not illustrated) formed so as to be arranged around the shaft F, and a plurality of fixed teeth (not illustrated) formed in a portion facing the movable teeth in the housing 600. By setting the shape of each tooth, when the operation section 602 is rotated (rotated forward) in the feeding direction of the wiping member 400A, the running surface allows the rotation, and when the operation section 602 is rotated (rotated backward) in the direction opposite to the feeding direction of the wiping member 400A, the movable teeth mesh with the fixed teeth to prevent the reverse rotation. Since the reverse rotation prevention structure 610 only needs to be able to prevent the reverse rotation of the operation section 602, it can be realized using various structures having a structure other than the running surface.

A drive gear 611 (also illustrated in FIG. 22) is fixed to the operation section 602. The drive gear 611 is disposed below the reverse rotation prevention structure 610, and rotates around the shaft F in conjunction with the rotation operation of the operation section 602. On the other hand, a driven gear 612 meshing with the drive gear 611 is disposed above the drive shaft 502. A coupling member 613 (illustrated in FIG. 20) that couples the driven gear 612 and the drive shaft 502 in a relatively non-rotatable manner is inserted and fixed inside the upper portion of the drive shaft 502. As illustrated in FIG. 22, the number of teeth of the driven gear 612 is set to be larger than the number of teeth of the drive gear 611, and thus the outer diameter of the driven gear 612 is larger than the outer diameter of the drive gear 611. The width of the housing 600 in the left-right direction is set so that the drive gear 611 having a large outer diameter can be accommodated.

When the operation section 602 rotates forward, the drive gear 611 also rotates in the same direction. Then, the driven gear 612 meshed with the drive gear 611 rotates in the direction indicated by the arrow H in FIG. 22, and the drive shaft 502 fixed to the driven gear 612 also rotates in the direction indicated by the arrow H. As illustrated in FIG. 19, when the drive shaft 502 rotates in the direction indicated by the arrow H, the wiping member 400A is wound. Therefore, on the side facing the print head 22 (the rear side of the cleaning unit 400), the wiping member 400A moves from the right side to the left side, that is, in a direction orthogonal to the direction in which the plurality of nozzles are arranged. In the present embodiment, the feeding amount of the wiping member 400A is set such that the adhering matter of the nozzle group 22a is removed when the operation section 602 is rotated once. Therefore, the predetermined cleaning operation can be completed by performing an operation of rotating the operation section 602 once.

The movement mechanism 600A that moves the wiping member 400A includes a drive gear 611, a driven gear 612, and a drive shaft 502. The drive gear 611 is a member that rotates in synchronization with the rotation of the operation section 602. Therefore, the movement mechanism 600A is configured to operate in conjunction with the operation of the operation section 602.

When the wiping member 400A is moved from right to left, the wiping member 400A abuts on the nozzle group 22a, so that the adhering matter adhered to the nozzle group 22a can be wiped off reliably. In the present embodiment, an abutment mechanism 600B is also provided as a mechanism for moving the wiping member 400A toward the nozzle group 22a to abut on the nozzle group 22a in a state where the cleaning unit 400 is attached to the print head 22. Therefore, the movement mechanism 600A moves the wiping member 400A from right to left in a state where the wiping member 400A abuts on the nozzle group 22a by the abutment mechanism 600B, thereby wiping off the adhering matter adhered to the nozzle group 22a.

FIG. 23 is a perspective view of the cleaning unit 400 in a state where the wiping member 400A is detached as viewed from the rear. When the wiping member 400A is detached, the abutment mechanism 600B can be visually recognized. The abutment mechanism 600B includes a bumper member 620 that abuts on the wiping member 400A from a side opposite to the nozzle group 22a and presses the wiping member 400A against the nozzle group 22a. Since the bumper member 620 is provided in the housing 600, the bumper member is inserted to the side of the wiping member 400A opposite to the nozzle group 22a when the cleaning cartridge 500 is accommodated in the housing 600.

The bumper member 620 includes an elastic material 621 provided at a position corresponding to the nozzle group 22a. The elastic material 621 is a member for pressing the wiping member 400A from the side opposite to the nozzle group 22a, and is made of, for example, a foam material such as sponge. The position of the elastic material 621 in the up-down direction is set to be the same as the position of the nozzle group 22a in the up-down direction in a state where the cleaning unit 400 is attached to the print head 22. The dimension of the elastic material 621 in the up-down direction is set to be larger than or equal to the dimension from the upper end portion to the lower end portion of the nozzle group 22a.

In a state before wiping, a portion of the wiping member 400A facing the print head 22 is positioned and provided at a predetermined standby position with respect to the housing 600. In other words, in a state where the cleaning unit 400 abuts on the front surface 201 of the print head 22 in which the nozzle group 22a is formed, the wiping member 400A is positioned at a predetermined standby position with respect to the nozzle group 22a and accommodated inside the housing 600. When the portion of the wiping member 400A facing the print head 22 is at the standby position, it is away forward from the nozzle group 22a or slightly in contact with the nozzle group 22a. By setting the standby position in this manner, when the cleaning unit 400 is attached to the print head 22 or when the cleaning unit 400 is detached from the print head 22, the wiping member 400A does not strongly contact the nozzle group 22a, and the nozzle group 22a can be protected. On the other hand, even if the wiping member 400A is moved in a state where the portion of the wiping member 400A facing the print head 22 is at the standby position, the wiping effect of the adhering matter is hardly expected.

On the other hand, the abutment mechanism 600B of the present embodiment is configured to move the wiping member 400A from the standby position toward the nozzle group 22a by a predetermined amount to abut on the nozzle group 22a with a predetermined pressing force, and move the wiping member 400A abutting on the nozzle group 22a by the predetermined amount in a direction away from the nozzle group 22a to return to the standby position.

Hereinafter, a specific structure of the abutment mechanism 600B will be described. As illustrated in FIG. 19, guided plates 620a extending in the front-rear direction are provided on both left and right sides of the bumper member 620. Inside the housing 600, left and right guided plates 620a are disposed between left and right guide portions 623 provided so as to extend in the front-rear direction, the left and right guide portions 623 guiding the guided plates 620a in the front-rear direction.

The abutment mechanism 600B includes an input member 625. The input member 625 is disposed on a side opposite to the elastic material 621 in the bumper member 620 and between the left and right guided plates 620a. The input member 625 is a member that is long in the up-down direction, and is fixed to the bumper member 620. An intermediate portion of the input member 625 in the left-right direction is formed of a curved portion 625a curved rearward.

The abutment mechanism 600B includes an input shaft 626. As illustrated in FIG. 20, the input shaft 626 extends in the up-down direction and is disposed coaxially with the shaft F. An upper portion of the input shaft 626 is fixed to a lower portion of the operation section 602, and a rotational force of the operation section 602 is input to the input shaft 626 so that the operation section 602 and the input shaft 626 rotate synchronously at a constant speed.

The abutment mechanism 600B includes an upper cam plate 627 and a lower cam plate 628. As illustrated in FIG. 24, the lower cam plate 628 is fixed to a lower portion of the input shaft 626 and is formed of a plate member extending in a direction orthogonal to the shaft F. On the upper surface of the lower cam plate 628, a lower cam groove 628a is formed so as to surround the shaft F. The lower cam groove 628a has an annular shape, and has a portion close to the shaft F and a portion away from the shaft F.

A lower driven portion 625b to be inserted into the lower cam groove 628a is provided in a lower portion of the input member 625 so as to protrude downward. When the input shaft 626 is rotated, the lower cam plate 628 rotates, and a force corresponding to the shape of the lower cam groove 628a is input to the lower driven portion 625b inserted into the lower cam groove 628a. Since the lower cam groove 628a has a portion close to the shaft F and a portion away from the shaft F, a force in the front-rear direction is input to the lower driven portion 625b. As a result, the force in the front-rear direction is transmitted to the bumper member 620 via the input member 625. The bumper member 620 moves while the guided plate 620a is guided in the front-rear direction by the guide portion 623.

As illustrated in FIG. 20, the upper cam plate 627 is configured similarly to the lower cam plate 628, is fixed to an upper portion of the input shaft 626 in a state of being disposed above the upper plate portion 504, and extends in a direction orthogonal to the shaft F. On the lower surface of the upper cam plate 627, an upper cam groove 627a is formed so as to surround the shaft F, and the shape of the upper cam groove 627a is the same as the shape of the lower cam groove 628a in the circumferential direction. Furthermore, the upper cam groove 627a and the lower cam groove 628a are in phase. An upper driven portion 625c provided in an upper portion of the input member 625 is inserted into the upper cam groove 627a. As a result, force in the same direction is also input to the upper portion of the input member 625 at the same timing as the lower portion, so that the bumper member 620 moves in a stable state.

As described above, when the user rotates the operation section 602, the bumper member 620 can be moved in the front-rear direction by the rotation of the upper cam plate 627 and the lower cam plate 628. By moving the bumper member 620 forward and separating it from the nozzle group 22a, the wiping member 400A can be kept at the standby position. By moving the bumper member 620 located on the front side rearward to approach the nozzle group 22a, the wiping member 400A located at the standby position can be moved by a predetermined amount toward the nozzle group 22a to abut on the nozzle group 22a. At this time, since the elastic material 621 of the bumper member 620 is compressed in the front-rear direction and elastically deformed, the wiping member 400A can be brought into close contact with the nozzle group 22a using the repulsive force of the elastic material 621. In other words, the movement of the bumper member 620 in the front-rear direction defined by the design of the rotation of the upper cam plate 627 and the lower cam plate 628 brings the wiping member 400A and the nozzle group 22a close to the contact position, and the fine relative position between the wiping member 400A and the nozzle group 22a is adjusted by the movement amount of the elastic deformation of the elastic material 621 of the bumper member 620. That is, the elastic material 621 plays a role of absorbing the influence of the dimensional tolerance of each member and the influence of the surrounding vibration environment, and bringing the wiping member 400A into close contact with the nozzle group 22a.

The pressing force of the wiping member 400A against the nozzle group 22a can be set by the shapes of the upper cam groove 627a and the lower cam groove 628a. In the present embodiment, the pressing force of the wiping member 400A is set so that the wiping member 400A can be kept in reliably abutting on the nozzle group 22a without applying an excessive load to the nozzle group 22a. When the operation section 602 is further rotated, the bumper member 620 moves forward and the wiping member 400A can be returned to the standby position. Bumper member 620 located at the standby position is switched to an abutment position during one rotation of operation section 602, and then returns to the standby position.

The abutment mechanism 600B is configured to operate in conjunction with the operation of the operation section 602. Since both the abutment mechanism 600B and the movement mechanism 600A operate in conjunction with the operation of the operation section 602, the operation of the abutment mechanism 600B and the operation of the movement mechanism 600A can be mechanically synchronized with each other.

As illustrated in FIG. 20, the housing 600 includes a first lock mechanism 600C that regulates the operation of the operation section 602 until the cleaning unit 400 is attached to the front end surface of the print head 22. FIGS. 25 and 26 are views illustrating a structure of the first lock mechanism 600C. The first lock mechanism 600C includes a rotating member 630 that rotates integrally with the operation section 602, an advancing and retracting member 631 that moves linearly relative to the housing 600 in the front-rear direction, and a locking gear 632. The rotating member 630 has an annular shape surrounding the upper cam plate 627, and is fixed to the upper cam plate 627. The rotation center of the rotating member 630 is located on the shaft F. A recess 630a recessed radially inward is formed at one location in the circumferential direction of the rotating member 630. The rotating member 630 rotates in synchronization with the operation section 602.

The locking gear 622 is disposed above the upper plate portion 504 and is fixed to an upper portion of the driven shaft 501. The position of the locking gear 622 in the height direction and the position of the rotating member 630 in the height direction are set to be the same.

The advancing and retracting member 631 is disposed at the same position as the position of the rotating member 630 in the height direction above the upper plate portion 504. A first tension spring 633 is provided on the side of the advancing and retracting member 631. One end portion of the first tension spring 633 is fixed to the upper plate portion 504, and the other end portion is fixed to the advancing and retracting member 631. The first tension spring 633 constantly applies a biasing force toward the rear side to the advancing and retracting member 631.

On the rear surface of the housing 600, first through holes 600a are formed on both left and right sides, respectively. A protrusion 631a inserted into the first through hole 600a is provided in a rear portion of the advancing and retracting member 631. In a state where the advancing and retracting member 631 is positioned on the rear side by the biasing force of the first tension spring 633, the protrusion 631a protrudes from the first through hole 600a to the rear side by a predetermined dimension or more (illustrated in FIG. 25). On the other hand, when a pressing force is applied forward to the protrusion 631a protruding backward from the first through hole 600a, the advancing and retracting member 631 moves forward against the biasing force of the first tension spring 633 (illustrated in FIG. 26).

A first lock piece 631b protruding rearward is formed at an intermediate portion of the advancing and retracting member 631 in the front-rear direction so as to correspond to the rotating member 630. The first lock piece 631b is disposed on the front side of the rotating member 630, and is fitted into the recess 630a of the rotating member 630 to lock the rotating member 630 so as not to rotate in a state where the advancing and retracting member 631 is positioned on the rear side as illustrated in FIG. 25. On the other hand, as illustrated in FIG. 26, when the advancing and retracting member 631 is located on the front side, the first lock piece 631b comes out of the recess 630a of the rotating member 630 and the rotating member 630 can rotate.

Furthermore, on the front side of the advancing and retracting member 631, a second lock piece 631c protruding rearward is formed so as to correspond to the locking gear 622. The second lock piece 631c is disposed on the front side of the locking gear 622, and meshes with the teeth of the locking gear 622 to lock the locking gear 622 so as not to rotate in a state where the advancing and retracting member 631 is positioned on the rear side as illustrated in FIG. 25. On the other hand, when the advancing and retracting member 631 is located on the front side as illustrated in FIG. 26, the second lock piece 631c is separated from the teeth of the locking gear 622, and the locking gear 622 can rotate.

When the cleaning unit 400 is detached from the print head 22, the protrusion 631a of the advancing and retracting member 631 is not pushed from the outside, and thus the cleaning unit protrudes from the first through hole 600a by a predetermined dimension or more. Therefore, as illustrated in FIG. 25, the rotation of the rotating member 630 and the locking gear 622 is locked by the advancing and retracting member 631.

When the cleaning unit 400 is attached to the print head 22, the protrusion 631a protruding from the first through hole 600a is pushed by the front end surface of the print head 22, and the advancing and retracting member 631 moves to the front side as illustrated in FIG. 26. This enables rotation of the rotating member 630 and the locking gear 622. By providing the first lock mechanism 600C in this manner, the operation section 602 cannot be operated in a state where the cleaning unit 400 is detached from the print head 22, and thus, the wiping member 400A can be prevented from being wastefully consumed.

The housing 600 includes a second lock mechanism 600D that regulates the operation of the operation section 602 when a predetermined cleaning operation is completed in a state where the cleaning unit 400 is attached to the front end surface of the print head 22. FIGS. 27 to 30 are diagrams illustrating the structure and operation of the second lock mechanism 600D. The second lock mechanism 600D includes a claw portion 640 provided on the upper portion of the drive gear 611, a locking portion 641 locked to the claw portion 640, and a movable member 642 that moves the locking portion 641. The claw portion 640 protrudes radially outward, so that a shape in which a part in the circumferential direction protrudes in the radial direction is provided on the upper portion of the drive gear 611. The claw portion 640 rotates in synchronization with the operation section 602.

The locking portion 641 is disposed on the front side of the claw portion 640 and is formed so as to protrude toward the rear side. The locking portion 641 is supported by the movable member 642 in a state of being attached to the movable member 642. As illustrated in FIG. 27, when the locking portion 641 abuts on the claw portion 640 from one side in the circumferential direction, the rotation of the drive gear 611, that is, the rotation of the operation section 602 is locked.

The movable member 642 that supports the locking portion 641 is a member that is disposed above the upper plate portion 504 and linearly moves relative to the housing 600 in the front-rear direction. A second tension spring 643 is provided on the side of the movable member 642. One end portion of the second tension spring 643 is fixed to the upper plate portion 504, and the other end portion is fixed to the movable member 642. The second tension spring 643 constantly applies a biasing force toward the rear side to the movable member 642.

On the rear surface of the housing 600, second through holes 600b (illustrated in FIG. 18 and the like) are formed on both left and right sides, respectively. A protrusion 642a inserted into the second through hole 600b is provided in the rear portion of the movable member 642. In a state where the movable member 642 is located on the rear side by the biasing force of the second tension spring 643, the protrusion 642a protrudes from the second through hole 600b to the rear side by a predetermined dimension or more (illustrated in FIG. 27). On the other hand, when a pressing force is applied forward to the protrusion 642a protruding backward from the second through hole 600b, the movable member 642 moves forward against the biasing force of the second tension spring 643 (illustrated in FIG. 28).

The locking portion 641 is attached to the movable member 642, and the locking portion 641 is interlocked with the movable member 642. The locking portion 641 is biased rightward by a biasing member 645. As illustrated in FIG. 28, when the movable member 642 moves to the front side, the locking portion 641 also moves to the front side and is separated from the claw portion 640. This is being unlocked. When the cleaning unit 400 is attached to the print head 22, the protrusion 642a protruding from the second through hole 600b is pushed forward by the release surface 230b (illustrated in FIG. 14) configured by a part of the front end surface of the upper cover 230. When the protrusion 642a is pushed by the release surface 230b, the movable member 642 and the claw portion 640 move to the front side as illustrated in FIG. 28. This enables rotation of the drive gear 611, that is, rotation of the operation section 602.

When the cleaning unit 400 moves below the release surface 230b and reaches the regular attachment position, the protrusion 642a and the release surface 230b are separated from each other in the up-down direction. Therefore, the movable member 642 moves to the rear side as illustrated in FIG. 29, and the locking portion 641 also moves to the rear side accordingly. At this previous stage, that is, at the moment of transition from the state illustrated in FIG. 27 to the state illustrated in FIG. 28, the locking portion 641 moves rightward with respect to the claw portion 640 by the biasing force of the biasing member 645. Therefore, even when the locking portion 641 moves rearward as illustrated in FIG. 29, the locking portion is not locked to the claw portion 640 and remains in an unlocked state.

When the user rotates the operation section 602 to rotate the drive gear 611, the claw portion 640 also rotates. During the rotation of the claw portion 640, the locking portion 641 slides on the upper outer peripheral surface of the drive gear 611. Eventually, when the rotation angle of the operation section 602 becomes close to 360°, the claw portion 640 abuts on and is locked to the locking portion 641 as illustrated in FIG. 30, so that the operation section 602 does not rotate one or more times. As a result, regardless of who performs cleaning, the same cleaning operation can be always executed using a necessary amount of the wiping member 400A, the personal nature can be eliminated, and wasteful use of the wiping member 400A can be suppressed.

When the cleaning unit 400 is detached from the print head 22, if the protrusion 642a protruding from the second through hole 600b hits the release surface 230b constituted by a part of the front end surface of the upper cover 230 and is pushed forward, the lock is released as illustrated in FIG. 28. Therefore, when the cleaning unit 400 is used next time, the operation section 602 can be rotated.

As illustrated in FIGS. 31 and 32, the housing 600 includes a third lock mechanism 600E that regulates separation of the cleaning unit 400 from the front end surface of the print head 22 until a predetermined cleaning operation is completed in a state where the cleaning unit 400 is attached to the front end surface of the print head 22. The third lock mechanism 600E includes a locking cam plate 660 and a lock pin 661. The locking cam plate 660 is disposed above the upper plate 504 and is fixed to a lower portion of the operation section 602. The locking cam plate 660 is formed of a plate member extending in a direction orthogonal to the shaft F, and rotates in synchronization with the operation section 602. Since the operation section 602 can rotate only one rotation by the second lock mechanism 600D, the locking cam plate 660 also rotates only one rotation.

On the upper surface of the locking cam plate 660, a locking cam groove 660a is formed so as to surround the shaft F. The locking cam groove 660a has an annular shape, and has a portion close to the shaft F and a portion away from the shaft F.

On the rear surface of the housing 600, a third through hole 600c is formed at an intermediate portion in the left-right direction. The lock pin 661 is disposed above the locking cam plate 660. The rear portion of the lock pin 661 is disposed above the upper plate 504, is provided so as to be able to protrude rearward from the third through hole 600c, and linearly moves relative to the housing 600 in the front-rear direction. A driven portion 661a inserted into the lock cam groove 660a is formed in a front portion of the lock pin 661 so as to protrude downward. When the operation section 602 is rotated to rotate the locking cam plate 660, a force corresponding to the shape of the locking cam groove 660a is input to the driven portion 661a inserted into the locking cam groove 660a. Since the locking cam groove 660a has a portion close to the shaft F and a portion away from the shaft F, a force in the front-rear direction is input to the driven portion 661a. As a result, the lock pin 661 can be moved in the front-rear direction to be switched between a lock position where the rear side portion of the lock pin 661 greatly protrudes rearward from the third through hole 600c as illustrated in FIG. 32 and an unlock position where the rear side portion of the lock pin 661 hardly protrudes rearward from the third through hole 600c as illustrated in FIG. 31. The timing of switching to the unlock position is a timing at which the predetermined cleaning operation is completed, and is synchronized with the second lock mechanism 600D.

As illustrated in FIGS. 14 and 15, an insertion hole 22f into which the rear side portion of the lock pin 661 is inserted is formed on the front end surface of the print head 22. The position of the insertion hole 22f coincides with the position of the third through hole 600c of the cleaning unit 400 attached to the print head 22. Therefore, when the lock pin 661 is switched to the lock position as illustrated in FIG. 32, the rear portion of the lock pin 661 is inserted into the insertion hole 22f, and the cleaning unit 400 cannot be moved upward, so that the cleaning unit 400 cannot be detached. On the other hand, when the lock pin 661 is switched to the unlock position, the rear portion of the lock pin 661 comes out of the insertion hole 22f and the cleaning unit 400 can be moved upward, so that the cleaning unit 400 can be detached. That is, since the cleaning unit 400 cannot be detached until the operation section 602 is rotated once, the cleaning unit 400 is not erroneously detached during cleaning.

As illustrated in FIG. 20, the cleaning unit 400 incorporates a magnet 670 that interlocks with the operation section 602. The magnet 670 is fixed to the upper cam plate 627, and moves from a position close to the rear surface of the housing 600 to a position away from the rear surface of the housing 600 to the front side by the rotation of the upper cam plate 627, and moves from a position away from the rear surface of the housing 600 to the front side to a position close to the rear surface of the housing 600.

As illustrated in FIGS. 14 and 15, a Hall element (detection section) 22e that detects the state of the cleaning unit 400 on the basis of a magnetic force of the magnet 670 is provided in the vicinity of the front end surface of the print head 22. In a case where a magnetic force greater than or equal to a predetermined value is detected by the Hall element 22e, it is determined that the cleaning unit 400 is attached to the print head 22 in a normal state. On the other hand, in a case where the Hall element 22e does not detect the magnetic force greater than or equal to the predetermined value, it is determined that the cleaning unit 400 is abnormal. The determination section that performs this determination may be configured by the control section 40 of the controller 4 or may be incorporated in the drawing machine body 25. In a case where it is determined that the cleaning unit 400 is abnormal, the user can be notified. Furthermore, it is also possible to determine whether or not cleaning is in progress on the basis of a detection result of the Hall element 22e.

As illustrated in FIG. 11 and the like, the housing 600 is provided with a dial 680 for removing the slack of the wiping member 400A. A part of the dial 680 in the circumferential direction is exposed from the front surface of the housing 600, and a user can operate a part of the dial 680 in the circumferential direction from the outside of the housing 600.

The dial 680 is fixed to an upper portion of the driven shaft 501. In a case where the wiping member 400A is slackened, the driven shaft 501 is rotated in the winding direction of the wiping member 400A by the operation of rotating the dial 680 from the outside by the user, and the slackening of the wiping member 400A can be detached.

The positioning of the wiping member 400A with respect to the nozzle group 22a will be described in detail. The housing 600 of the cleaning unit 400 has a wiping surface on which the wiping member 400A is exposed in a state of being pushed out by at least the abutment mechanism. The wiping surface is provided with the rail portion 401, the movable member 642, and the advancing and retracting member 631. The user holds the housing 600 of the cleaning unit 400 by hand and causes the wiping surface of the housing 600 to abut on the front surface 201 of the print head 22. Since the cleaning unit 400 is configured such that the wiping member 400A is positioned and held at least in the front-rear direction with respect to the wiping surface, the wiping member 400A is positioned at least in the front-rear direction with respect to the nozzle group 22a formed on the front surface 201 in a state where the wiping surface of the housing 600 abuts on the front surface 201 of the print head 22. As described above, by devising the design of the cleaning unit 400 and mechanically positioning in the front-rear direction, the user can clean the nozzle group 22a as intended by manual operation without making an error in the amount of force to press the wiping member 400A against the nozzle group 22a.

The above-described embodiments are merely examples in all respects, and should not be construed in a limiting manner. Moreover, all modifications and changes falling within the equivalent scope of the claims are within the scope of the present invention.

As described above, the present disclosure can be used in a case of removing an adhering matter adhered to a nozzle group.

What is claimed is:

1. A drawing machine that ejects ink for drawing information on an object to be drawn conveyed by a conveyor, the drawing machine comprising:
an ink tank configured to accommodate ink;
a print head configured to eject ink supplied from the ink tank toward the object to be drawn that is being conveyed;
a nozzle group including a plurality of nozzles arranged side by side on one end face of the print head;
a purge control section configured to execute a purge process of causing ink remaining in a flow path from the ink tank to the nozzle group to leak to an outside through the nozzle group; and
a cleaning unit including a wiping member that wipes off an adhering matter adhered to the nozzle group by the purge process and configured to position the wiping member with respect to the nozzle group in a state of abutting on the one end face of the print head.

2. The drawing machine according to claim 1, wherein
the cleaning unit positions the wiping member with respect to the nozzle group in a state of abutting on the one end face of the print head through a manual operation of a user.

3. The drawing machine according to claim 2, wherein
the cleaning unit is detachably attached to the print head through the manual operation of the user, and abuts on the one end face of the print head in a state of being attached to the print head.

4. The drawing machine according to claim 1, wherein
the cleaning unit includes:
an abutment mechanism configured to move the wiping member toward the nozzle group to abut on the nozzle group in a state of being attached to the print head; and
a movement mechanism configured to wipe off an adhering matter adhered to the nozzle group by moving the wiping member in a direction orthogonal to a direction in which the plurality of nozzles are arranged in a state where the wiping member abuts on the nozzle group by the abutment mechanism.

5. The drawing machine according to claim 1, further comprising:
an elastic material configured to press the wiping member from a side opposite to the nozzle group; and
an abutment mechanism configured to move the wiping member toward the nozzle group to abut on the nozzle group in a state of being attached to the print head.

6. The drawing machine according to claim 4, wherein
the cleaning unit includes a housing configured to accommodate the abutment mechanism,
the wiping member is positioned and provided at a predetermined standby position with respect to the housing, and
the abutment mechanism moves the wiping member from the standby position toward the nozzle group by a predetermined amount to abut on the nozzle group, and moves the wiping member abutting on the nozzle group by the predetermined amount in a direction away from the nozzle group to return to the standby position.

7. The drawing machine according to claim 6, further comprising
an operation section provided in the housing and configured to perform a feeding operation of the wiping member,
wherein at least one of the abutment mechanism and the movement mechanism is configured to operate in conjunction with an operation of the operation section.

8. The drawing machine according to claim 7, further comprising a first lock mechanism configured to regulate the operation of the operation section until the cleaning unit is attached to the one end face of the print head.

9. The drawing machine according to claim 7, further comprising a second lock mechanism configured to regulate the operation of the operation section when a predetermined cleaning operation is completed in a state where the cleaning unit is attached to the one end face of the print head.

10. The drawing machine according to claim 7, further comprising a third lock mechanism configured to regulate separation of the cleaning unit from the one end face of the print head until a predetermined cleaning operation is completed in a state where the cleaning unit is attached to the one end face of the print head.

11. The drawing machine according to claim 1, further comprising:
an absorber configured to absorb ink leaking from the nozzle group by the purge process; and
a tray provided below the nozzle group and configured to guide the ink leaking from the nozzle group to the absorber.

12. The drawing machine according to claim 1, wherein
a sliding portion extending in an arrangement direction of the nozzle group is formed on the one end face of the print head, and
the cleaning unit is attached by sliding in the arrangement direction of the nozzle group with respect to the sliding portion of the print head.

13. The drawing machine according to claim 7, wherein
the cleaning unit incorporates a magnet configured to interlock with the operation section, and
the drawing machine includes a detection section configured to detect a state of the cleaning unit on a basis of a magnetic force of the magnet.

14. A cleaning unit that is detachably attached to a drawing machine including an ink tank configured to accommodate ink, a print head configured to eject ink supplied from the ink tank toward the object to be drawn that is being conveyed, a nozzle group including a plurality of nozzles arranged side by side on one end face of the print head, and a purge control section configured to execute a purge process of causing ink remaining in a flow path from the ink tank to the nozzle group to leak to an outside through the nozzle group, the cleaning unit comprising:
a wiping member configured to wipe off an adhering matter adhered to the nozzle group by the purge process; and
an attachment portion detachably attached to the one end face of the print head on which the nozzle group is arranged and configured to position the wiping member with respect to the nozzle group.

15. The cleaning unit according to claim 14, further comprising:
an abutment mechanism configured to move the wiping member toward the nozzle group to abut on the nozzle group in a state of being attached to the print head; and
a movement mechanism configured to wipe off an adhering matter adhered to the nozzle group by moving the wiping member in a direction orthogonal to a direction in which the plurality of nozzles are arranged in a state where the wiping member abuts on the nozzle group by the abutment mechanism.
